(19) United States
(12) Patent Application Publication
(10) Pub. No.: US 2026/0260595 A1
(43) Pub. Date: Sep. 3, 2026

(54) DRIVING MODULE, DRIVING METHOD AND DISPLAY DEVICE

(71) Applicants: Fuzhou BOE Optoelectronics Technology Co., Ltd., Fuzhou, Fujian (CN); BOE TECHNOLOGY GROUP CO., LTD., Beijing (CN)

(72) Inventors: Zongxiang LI, Beijing (CN); Xin LIN, Beijing (CN); Baoqiang WANG, Beijing (CN); Xu XU, Beijing (CN); Yao LIU, Beijing (CN); Wenchao WANG, Beijing (CN); Bo HU, Beijing (CN); Xin XIE, Beijing (CN)

(21) Appl. No.: 18/995,767

(22) PCT Filed: May 23, 2024
(86) PCT No.: PCT/CN2024/094852

§ 371 Date: Jan. 16, 2025

(30) Foreign Application Priority Data
Jun. 19, 2023 (CN) 202310729342.6

(51) Int. Cl. G09G 3/20

(52) U.S. Cl. CPC G09G 3/2092; G09G 2300/0819; G09G 2320/045

(57) ABSTRACT

The present disclosure provides a driving module, a driving method, and a display device. The driving module includes multiple stages of driving circuits; the driving circuit includes an input circuit, a first reset circuit, and a second reset circuit. The input circuit controls the potential of the pull-up node based on the input signal. The first reset circuit, under the control of the first reset signal, inputs a first voltage signal to the pull-up node. The first pull-down noise reduction circuit, under the control of the potential of the first pull-down node, inputs a second voltage signal to the pull-up node. The voltage value of the first voltage signal is greater than the voltage value of the second voltage signal.

### CROSS-REFERENCE TO RELATED APPLICATIONS

This application is the U.S. national phase of PCT Application No. PCT/CN2024/094852 filed on May 23, 2024, which claims priority to Chinese Patent Application No. 202310729342.6 filed on Jun. 19, 2023, the disclosures each of which are incorporated in their entirety by reference herein for all purposes.

### TECHNICAL FIELD

The present disclosure relates to the field of display technology, and in particular to a driving module, a driving method, and a display device.

### BACKGROUND

In related driving circuits, a first transistor is used for resetting a pull-up node through a third low-voltage signal provided by a third low-voltage terminal. The voltage value of the third low-voltage signal provided by the third low-voltage terminal is relatively low, resulting in a relatively large absolute value of the drain-source voltage of the first transistor and a relatively high impact current of the first transistor. This causes characteristic drift of the first transistor, leading to a severe deficiency in its conduction current. Consequently, the potential of the pull-up node cannot be pulled down, causing the cascade relationship to fail and affecting the reliability of the display product.

### SUMMARY

In one aspect, the embodiments of the present disclosure provide a driver module, comprising a multi-stage driver circuit;
the driver circuit includes an input circuit, a first reset circuit, and a first pull-down noise reduction circuit;
the input circuit is electrically connected to the input terminal and the pull-up node, for controlling the potential of the pull-up node based on the input signal provided by the input terminal;
the first reset circuit is electrically connected to the first reset terminal, the pull-up node, and the first voltage source terminal, for inputting the first voltage signal provided by the first voltage source terminal to the pull-up node under the control of the first reset signal provided by the first reset terminal;
the first pull-down noise reduction circuit is connected to the first pull-down node, the pull-up node, and the second voltage source terminal; the first pull-down noise reduction circuit is configured to input the second voltage signal provided by the second voltage source terminal to the pull-up node under the control of the potential of the first pull-down node;
the voltage value of the first voltage signal is greater than that of the second voltage signal.

Optionally, the driver circuit further includes a second reset circuit;
the second reset circuit is electrically connected to the first pull-down node, the pull-up node of an adjacent preceding m-th stage driver circuit, and the second voltage source terminal, for controlling connection or disconnection between the pull-up node of the adjacent preceding m-th stage driver circuit and the second voltage source terminal under the control of the potential of the first pull-down node;
m is a positive integer.

Optionally, the driver circuit further includes a second reset circuit;
the second reset circuit is electrically connected to the first pull-down node, the pull-up node, and the second voltage source terminal, for controlling connection or disconnection between the pull-up node and the second voltage source terminal under the control of the potential of the first pull-down node.
Optionally, the driver circuit further includes a third reset circuit;
the third reset circuit is electrically connected to the second pull-down node, the pull-up node of an adjacent preceding m-th stage driver circuit, and the second voltage source terminal, for controlling connection or disconnection between the pull-up node of the adjacent preceding m-th stage driver circuit and the second voltage source terminal under the control of the potential of the second pull-down node.

Optionally, the driver circuit further includes a third reset circuit;
the third reset circuit is electrically connected to the second pull-down node, the pull-up node, and the second voltage source terminal, for controlling connection or disconnection between the pull-up node and the second voltage source terminal under the control of the potential of the second pull-down node.

Optionally, the driver circuit further includes a second pull-down noise reduction circuit;
the second pull-down noise reduction circuit is electrically connected to the second pull-down node, the pull-up node, and the second voltage source terminal; the second pull-down noise reduction circuit is configured to input the second voltage signal provided by the second voltage source terminal to the pull-up node under the control of the second pull-down node.

Optionally, the driver circuit further includes a first noise reduction circuit;
the first noise reduction circuit is electrically connected to the first noise reduction control terminal, the first pull-down node, and the second voltage source terminal, for controlling connection or disconnection between the first pull-down node and the second voltage source terminal under the control of the first noise reduction control signal provided by the first noise reduction control terminal;
the first noise reduction control terminal is either the input terminal of an adjacent preceding m-th stage driver circuit or the first reset terminal.

Optionally, the driver circuit further includes a second noise reduction circuit;
the second noise reduction circuit is electrically connected to the second noise reduction control terminal, the second pull-down node, and the second voltage source terminal, for controlling connection or disconnection between the second pull-down node and the second voltage source terminal under the control of the second noise reduction control signal provided by the second noise reduction control terminal;
the second noise reduction control terminal is either the input terminal of an adjacent preceding m-th stage driver circuit or the first reset terminal; m is a positive integer.

Optionally, the first reset circuit includes a first transistor;
the gate of the first transistor is connected to the first reset terminal, the first terminal of the first transistor is connected to the pull-up node, and the second terminal of the first transistor is connected to the first voltage source terminal;

Optionally, the channel length of the first transistor is greater than a channel length threshold, and the width-to-length ratio of the channel of the first transistor is less than a width-to-length ratio threshold.

Optionally, the second reset circuit includes a second transistor;
the gate of the second transistor is connected to the first pull-down node, the first terminal of the second transistor is connected to the pull-up node of an adjacent preceding m-th stage driver circuit, and the second terminal of the second transistor is connected to the second voltage source terminal.

Optionally, the second reset circuit includes a second transistor;
the gate of the second transistor is connected to the first pull-down node, the first terminal of the second transistor is connected to the pull-up node, and the second terminal of the second transistor is connected to the second voltage source terminal.

Optionally, the third reset circuit includes a third transistor;
the gate of the third transistor is connected to the second pull-down node, the first terminal of the third transistor is connected to the pull-up node of an adjacent preceding m-th stage driver circuit, and the second terminal of the third transistor is connected to the second voltage source terminal.

Optionally, the third reset circuit includes a third transistor;
the gate of the third transistor is connected to the second pull-down node, the first terminal of the third transistor is connected to the pull-up node, and the second terminal of the third transistor is connected to the second voltage source terminal.

Optionally, the first noise reduction circuit includes a fourth transistor;
the gate of the fourth transistor is connected to the first noise reduction control terminal, the first terminal of the fourth transistor is connected to the first pull-down node, and the second terminal of the fourth transistor is connected to the second voltage source terminal.

Optionally, the second noise reduction circuit includes a fifth transistor;
the gate of the fifth transistor is connected to the second noise reduction control terminal, the first terminal of the fifth transistor is connected to the second pull-down node, and the second terminal of the fifth transistor is connected to the second voltage source terminal.

Optionally, the driver circuit further includes a driving signal output terminal and a driving reset circuit;
the driving reset circuit is connected to the pull-down node, the driving signal output terminal, and the first voltage source terminal, for controlling connection or disconnection between the driving signal output terminal and the first voltage source terminal under the control of the potential of the pull-down node; or,
the driving reset circuit is connected to the pull-down node, the driving signal output terminal, and a third voltage source terminal, for controlling connection or disconnection between the driving signal output terminal and the third voltage source terminal under the control of the potential of the pull-down node; the third voltage source terminal is different from the first voltage source terminal.

### BRIEF DESCRIPTION OF THE DRAWINGS

FIG. 1 is a circuit diagram of a related driver circuit;

FIG. 2A is a timing diagram of the related driver circuit shown in FIG. 1;

FIG. 2B is the characteristic curve of the first transistor in the related driver circuit shown in FIG. 1;

FIG. 3 is a structural diagram of the driver circuit described in the embodiments of the present disclosure;

FIG. 4 is a structural diagram of the driver circuit according to at least one embodiment of the present disclosure;

FIG. 5 is a structural diagram of the driver circuit according to at least one embodiment of the present disclosure;

FIG. 6 is a structural diagram of the driver circuit according to at least one embodiment of the present disclosure;

FIG. 7 is a structural diagram of the driver circuit according to at least one embodiment of the present disclosure;

FIG. 8 is a structural diagram of the driver circuit according to at least one embodiment of the present disclosure;

FIG. 9 is a structural diagram of the driver circuit according to at least one embodiment of the present disclosure;

FIG. 10 is a circuit diagram of the driver circuit according to at least one embodiment of the present disclosure;

FIG. 11 is a circuit diagram of the driver circuit according to at least one embodiment of the present disclosure;

FIG. 12 is a timing diagram of at least one embodiment of the driver circuit shown in FIG. 11;

FIG. 13 is a circuit diagram of the driver circuit according to at least one embodiment of the present disclosure;

FIG. 14 is a timing diagram of at least one embodiment of the driver circuit shown in FIG. 13;

FIG. 15 is a circuit diagram of the driver circuit according to at least one embodiment of the present disclosure;

FIG. 16 is a timing diagram of at least one embodiment of the driver circuit shown in FIG. 15;

FIG. 17 is a circuit diagram of the driver circuit according to at least one embodiment of the present disclosure;

FIG. 18 is a timing diagram of at least one embodiment of the driver circuit shown in FIG. 17;

FIG. 19A is a simulation waveform diagram of the driving signal output by G1 during operation in at least one embodiment of the driver circuit shown in FIG. 15;

FIG. 19B is a simulation waveform diagram of the driving signal output by G1 during operation of the related driver circuit;

FIG. 19C is a simulation waveform diagram of the pull-up node PU during operation in at least one embodiment of the driver circuit shown in FIG. 15;

FIG. 19D is a simulation waveform diagram of the pull-up node PU during operation in at least one embodiment of the related driver circuit;

FIG. 19E is a simulation waveform diagram of the first pull-down node PD1 during operation in at least one embodiment of the driver circuit shown in FIG. 15;

FIG. 19F is a simulation waveform diagram of the first pull-down node PD1 during operation in at least one embodiment of the driver circuit shown in FIG. 15;

FIG. 19G is a comparison diagram of simulation waveform X3 of the driving signal output by G1 during operation in at least one embodiment of the driver circuit shown in FIG. 15, and simulation waveform X4 of the driving signal output by G1 during operation of the related driver circuit;

FIG. 19H is a comparison diagram of waveform X5 representing the potential of the pull-up node PU during operation in at least one embodiment of the driver circuit shown in FIG. 15, and waveform X6 representing the potential of the pull-up node PU during operation of the related driver circuit;

FIG. 19I is a comparison diagram of waveform X7 representing the potential of the pull-down node PD during operation in at least one embodiment of the driver circuit shown in FIG. 15, and waveform X8 representing the potential of the pull-down node PD during operation of the related driver circuit;

FIG. 20 is a structural diagram of the first transistor in the related driver circuit;

FIG. 21 is a structural diagram of the first transistor in at least one embodiment described in the present disclosure;

FIG. 22A is a layout diagram of the gate metal layer in FIG. 21;

FIG. 22B is a layout diagram of the semiconductor layer in FIG. 21;

FIG. 22C is a layout diagram of the source-drain metal layer in FIG. 21;

FIG. 23 is a structural diagram of the driver module in at least one embodiment described in the present disclosure;

FIG. 24 is a timing diagram of at least one embodiment of the driver module shown in FIG. 23.

### DETAILED DESCRIPTION

The following will be described in conjunction with the accompanying drawings in the embodiments of the present disclosure, to clearly and completely describe the technical solution in the embodiments of the present disclosure. Evidently, the described embodiments are merely part of the embodiments of the present disclosure, not all of them. Based on the embodiments of the present disclosure, all other embodiments obtained by a person skilled in the art without exerting creative labor shall fall within the scope of protection of the present disclosure.

The transistors used in all embodiments of the present disclosure can be thin-film transistors (TFTs), field-effect transistors (FETs), or other devices with similar characteristics. In the embodiments of the present disclosure, to distinguish between the two terminals of a transistor other than the gate, one terminal is referred to as the first terminal, and the other terminal is referred to as the second terminal.

In actual operation, when the transistors are thin-film transistors or field-effect transistors, the first terminal may be the drain, and the second terminal may be the source; alternatively, the first terminal may be the source, and the second terminal may be the drain.

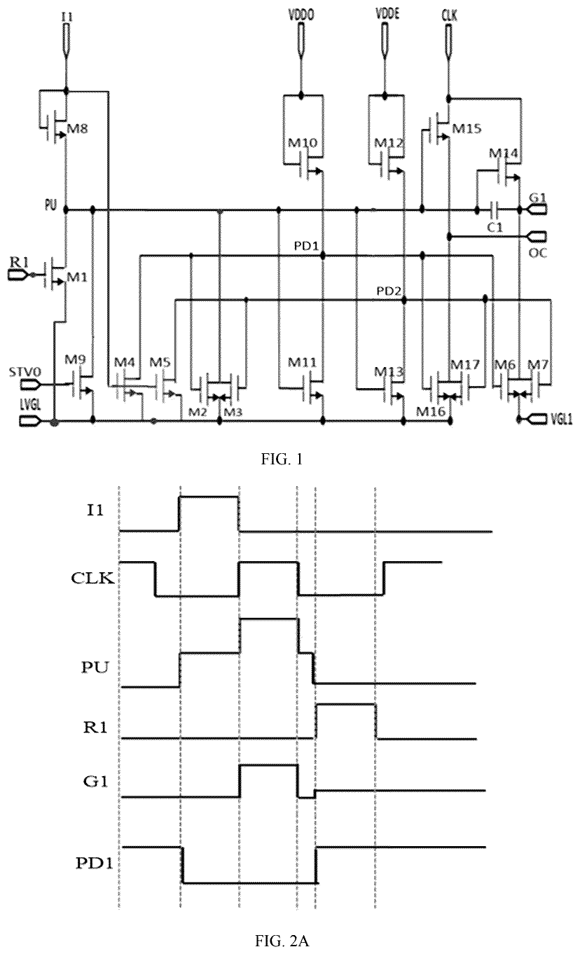

As shown in FIG. 1, in the related driver circuit, the drain of the first transistor M1 is connected to the third low-voltage terminal LVGL. The third low-voltage terminal LVGL provides a third low-voltage signal with a relatively low voltage value. As a result, the absolute value of the drain-source voltage of the first transistor M1 becomes large, leading to a large impact current for the first transistor M1. This causes characteristic drift of M1, resulting in insufficient conduction current Ion of M1. Consequently, the potential of the pull-up node cannot be lowered, causing cascading relationships to fail and thereby affecting the reliability of display products. In the related driver circuit shown in FIG. 1, all transistors are n-type transistors.

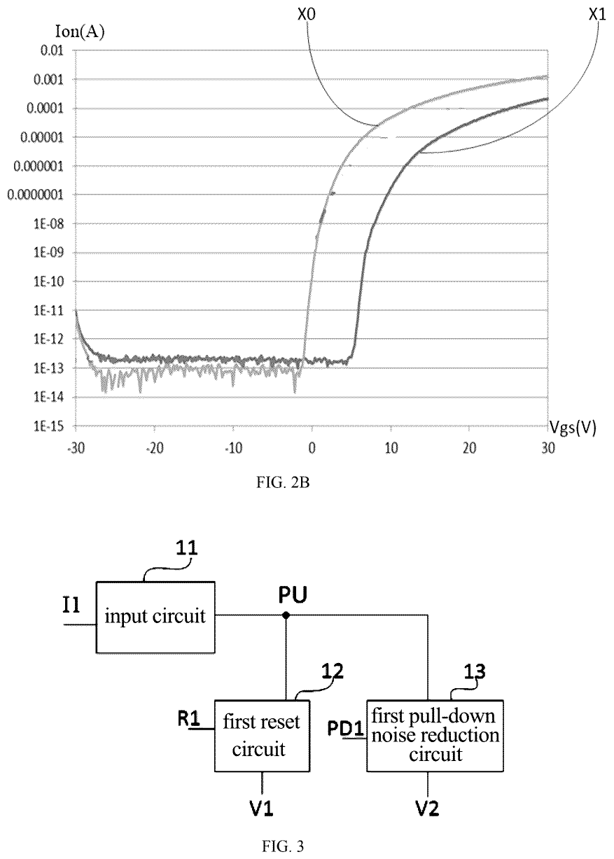

FIG. 2A is an operational timing diagram of the related driver circuit shown in FIG. 1.

As shown in FIG. 2A, when the potential of the pull-up node is at a high voltage, the potential of the first pull-down node PD1 is at a low voltage. The pull-up node PU resets after a delay of 1 H (where 1 H refers to the scanning time for a single row). Under the control of the potential of the pull-up node PU, G1 is connected with CLK, whereupon CLK outputs a low-voltage signal, and the driving signal output by G1 is initially pulled down to the third low-voltage value (the third low-voltage value corresponds to the voltage value of the third low-voltage signal provided by the third low-voltage terminal LVGL; the low voltage of the clock signal provided by the clock signal terminal CLK also corresponds to this third low-voltage value). Subsequently, when the potential of PD1 or PD2 reaches high voltage, the potential of the driving signal output by G1 is further pulled down to the first low voltage value (the first low voltage value corresponds to the voltage value of the first low voltage signal provided by the first low voltage terminal VGL1). The discloser has found that, since the third low-voltage value is smaller than the first low-voltage value, the delay at the driving signal output terminal becomes smaller. This facilitates charging and prevents incorrect charging in large displays. However, the pull-up node PU maintains a high voltage for a prolonged time (e.g., 9 H), resulting in an extended bias duration. Due to the bootstrap elevation effect on PU's voltage, the source-drain voltage difference across M1 is significant, increasing the likelihood of M1 experiencing characteristic drift.

Based on this, this embodiment of the present disclosure reduces the absolute value of the drain-source voltage of the transistor included in the first reset circuit to prevent characteristic drift of the transistor included in the first reset circuit, thereby enhancing the reliability of the display product.

In FIG. 2B, the curve labeled X0 represents the initial characteristic curve of M1, and the curve labeled X1 represents the characteristic curve of M1 after its characteristic drift.

As shown in FIG. 2B, when M1 undergoes characteristic drift, the characteristic curve of M1 shifts to the right and bends downward. When the gate-source voltage of M1 exceeds its threshold voltage, causing M1 to turn on, the conduction current Ion of M1 diminishes, preventing PU's potential from being raised.

In FIG. 2B, the horizontal axis represents the gate-source voltage Vgs, measured in volts (V), and the vertical axis represents the conduction current Ion, measured in amperes (A).

In FIG. 1:
M2 represents the second transistor.
M3 represents the third transistor.
M4 represents the fourth transistor.
M5 represents the fifth transistor.
M6 represents the sixth transistor.
M7 represents the seventh transistor.
M8 represents the eighth transistor.
M9 represents the ninth transistor.
M10 represents the tenth transistor.
M11 represents the eleventh transistor.
M12 represents the twelfth transistor.
M13 represents the thirteenth transistor.
M14 represents the fourteenth transistor.
M15 represents the fifteenth transistor.
M16 represents the sixteenth transistor.
M17 represents the seventeenth transistor.
C1 represents the storage capacitor.
I1 represents the input terminal.
R1 represents the first reset terminal.
PU represents the pull-up node.
PD1 represents the first pull-down node.
PD2 represents the second pull-down node.
VDDO represents the first control voltage terminal.
VDDE represents the second control voltage terminal.
CLK represents the clock signal terminal.
G1 represents the driving signal output terminal.
OC represents the carry-out terminal.
VGL1 represents the first low-voltage terminal.
STV0 represents the frame-reset terminal.

The driver module described in this embodiment of the present disclosure includes multi-stage driver circuits. As shown in FIG. 3, the driver circuit comprises an input circuit 11, a first reset circuit 12, and a first pull-down noise reduction circuit 13.

The input circuit 11 is electrically connected to the input terminal I1 and the pull-up node PU. It is configured to control the potential of the pull-up node PU based on the input signal provided at the input terminal I1.

The first reset circuit 12 is electrically connected to the first reset terminal R1, the pull-up node PU, and the first voltage terminal V1; it serves to input the first voltage signal from the first voltage terminal V1 to the pull-up node PU under the control of the first reset signal provided by the first reset terminal R1.

The first pull-down noise reduction circuit 13 is electrically connected to the first pull-down node PD1, the pull-up node PU, and the second voltage terminal V2. The first pull-down noise reduction circuit 13 inputs the second voltage signal provided by the second voltage terminal V2 to the pull-up node PU under the control of the potential of the first pull-down node PD1.

The voltage value of the first voltage signal is greater than the voltage value of the second voltage signal.

In the embodiments of the present disclosure, when resetting the potential of the pull-up node PU, the first reset circuit 12 ensures conduction between the pull-up node PU and the first voltage terminal V1 under the control of the first reset signal provided by the first reset terminal R1. The first pull-down noise reduction circuit 13 inputs the second voltage signal from the second voltage terminal V2 to the pull-up node PU under the control of the potential of the first pull-down node PD1. Since the voltage value of the first voltage signal is greater than that of the second voltage signal, the absolute value of the drain-source voltage across the transistor included in the first reset circuit 12 is reduced. This prevents characteristic drift of the transistor included in the first reset circuit 12, thus enhancing the reliability of the display product.

Optionally, the first voltage terminal may be the first low-voltage terminal or the second low-voltage terminal, and the second voltage terminal may be the third low-voltage terminal; however, this is not limited thereto.

In at least one embodiment of the present disclosure, the voltage value of the first low-voltage signal provided by the first low-voltage terminal can be −10V or −8V; the voltage value of the second low-voltage signal provided by the second low-voltage terminal can be −10V or −8V; the voltage value of the third low-voltage signal provided by the third low-voltage terminal can be −15V; however, these values are not limited thereto.

Optionally, the voltage value of the first low-voltage signal and the second low-voltage signal may range from greater than or equal to −12V to less than or equal to −7V, and the voltage value of the third low-voltage signal may range from greater than or equal to −18V to less than or equal to −13V.

In at least one embodiment of the present disclosure, the driver circuit may further include a second reset circuit:

The second reset circuit is electrically connected to the first pull-down node, the pull-up node of an adjacent preceding m-th stage driver circuit, and the second voltage terminal. It is configured to control the conduction or disconnection between the pull-up node of the adjacent preceding m-th stage driver circuit and the second voltage terminal under the control of the potential of the first pull-down node, where m is a positive integer.

In specific implementations, the driver circuit may include a second reset circuit. The second reset circuit, under the control of the potential of the first pull-down node, resets the pull-up node of the adjacent preceding m-th stage driver circuit. Additionally, the pull-up node of the current stage driver circuit may be reset through the first pull-down node of an adjacent subsequent m-th stage driver circuit, ensuring that the transistor included in the first reset circuit of the current-stage driver circuit and the transistor included in the second reset circuit of the adjacent subsequent m-th stage driver circuit do not turn on simultaneously, thereby avoiding short-circuits.

In at least one embodiment of the present disclosure, the driver circuit further includes a second reset circuit:

The second reset circuit is electrically connected to the first pull-down node, the pull-up node, and the second voltage terminal. It is used to control conduction or disconnection between the pull-up node and the second voltage terminal under the control of the potential of the first pull-down node.

In specific implementations, the driver circuit may include a second reset circuit. The second reset circuit, under the control of the potential of the first pull-down node, controls the conduction or disconnection between the pull-up node and the second voltage terminal.

In at least one embodiment of the present disclosure, the driver circuit further includes a third reset circuit:

The third reset circuit is electrically connected to the second pull-down node, the pull-up node of an adjacent preceding m-th stage driver circuit, and the second voltage terminal. It is used to control conduction or disconnection between the pull-up node of the adjacent preceding m-th stage driver circuit and the second voltage terminal under the control of the potential of the second pull-down node, where m is a positive integer.

In specific implementations, the driver circuit may include a third reset circuit. The third reset circuit, under the control of the potential of the second pull-down node, resets the pull-up node of the adjacent preceding m-th stage driver circuit. Additionally, the pull-up node of the current-stage driver circuit may be reset through the second pull-down node of an adjacent subsequent m-th stage driver circuit, ensuring that the transistor included in the first reset circuit of the current-stage driver circuit and the transistor included in the third reset circuit of the adjacent subsequent m-th stage driver circuit do not turn on simultaneously, thereby avoiding short-circuits.

In at least one embodiment of the present disclosure, the driver circuit further includes a third reset circuit:

The third reset circuit is electrically connected to the second pull-down node, the pull-up node, and the second voltage terminal. It is used to control conduction or disconnection between the pull-up node and the second voltage terminal under the control of the potential of the second pull-down node.

In specific implementations, the driver circuit may also include a third reset circuit. The third reset circuit, under the control of the potential of the second pull-down node, controls the conduction or disconnection between the pull-up node and the second voltage terminal.

In at least one embodiment of the present disclosure, the driver circuit further includes a first noise reduction circuit:

The first noise reduction circuit is electrically connected to the first noise reduction control terminal, the first pull-down node, and the second voltage terminal. It is configured to control conduction or disconnection between the first pull-down node and the second voltage terminal under the control of the first noise reduction control signal provided by the first noise reduction control terminal.

The first noise reduction control terminal may either correspond to the input terminal of the adjacent preceding m-th stage driver circuit or the first reset terminal.

In specific implementations, the driver circuit may additionally include a first noise reduction circuit. The first noise reduction circuit acts under the control of the first noise reduction control signal to reset the potential of the first pull-down node.

In at least one embodiment of the present disclosure, the driver circuit further includes a second noise reduction circuit:

The second noise reduction circuit is electrically connected to the second noise reduction control terminal, the second pull-down node, and the second voltage terminal. It is configured to control conduction or disconnection between the second pull-down node and the second voltage terminal under the control of the second noise reduction control signal provided by the second noise reduction control terminal.

The second noise reduction control terminal may correspond to the input terminal of the adjacent preceding m-th stage driver circuit or the first reset terminal, where m is a positive integer.

In specific implementations, the driver circuit may also include a second noise reduction circuit. The second noise reduction circuit acts under the control of the second noise reduction control signal to reset the potential of the second pull-down node.

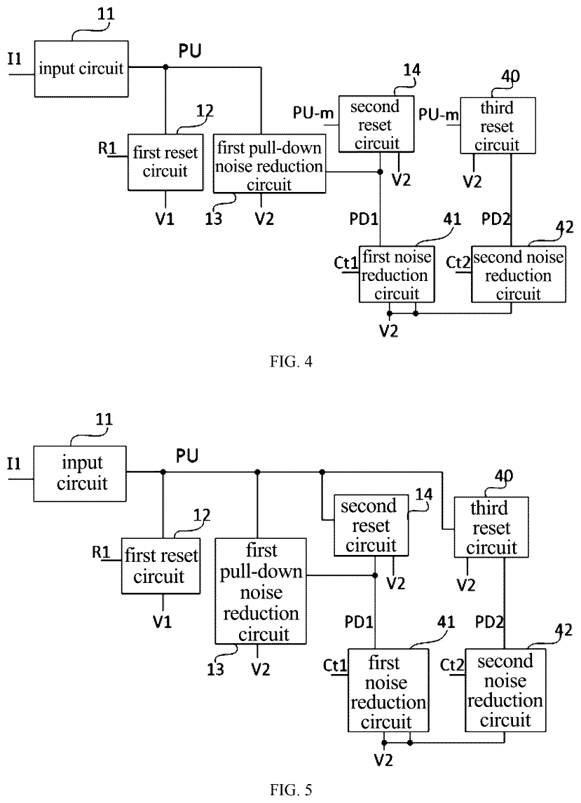

As shown in FIG. 4, based on at least one embodiment of the driver circuit shown in FIG. 3, at least one embodiment of the driver circuit further includes a second reset circuit 14, a third reset circuit 40, a first noise reduction circuit 41, and a second noise reduction circuit 42:

The second reset circuit 14 is electrically connected to the first pull-down node PD1, the pull-up node PU-m of the adjacent preceding m-th stage driver circuit, and the second voltage terminal V2. It controls conduction or disconnection between the pull-up node PU-m of the adjacent preceding m-th stage driver circuit and the second voltage terminal V2 under the control of the potential of the first pull-down node PD1.

The third reset circuit 40 is electrically connected to the second pull-down node PD2, the pull-up node PU-m of the adjacent preceding m-th stage driver circuit, and the second voltage terminal V2. It controls conduction or disconnection between the pull-up node PU-m of the adjacent preceding m-th stage driver circuit and the second voltage terminal V2 under the control of the potential of the second pull-down node PD2.

The first noise reduction circuit 41 is electrically connected to the first noise reduction control terminal Ct1, the first pull-down node PD1, and the second voltage terminal V2. It controls conduction or disconnection between the first pull-down node PD1 and the second voltage terminal V2 under the control of the first noise reduction control signal provided by the first noise reduction control terminal Ct1.

The second noise reduction circuit 42 is electrically connected to the second noise reduction control terminal Ct2, the second pull-down node PD2, and the second voltage terminal V2. It controls conduction or disconnection between the second pull-down node PD2 and the second voltage terminal V2 under the control of the second noise reduction control signal provided by the second noise reduction control terminal Ct2.

As shown in FIG. 5, based on at least one embodiment of the driver circuit shown in FIG. 3, at least one embodiment of the driver circuit further includes a second reset circuit 14, a third reset circuit 40, a first noise reduction circuit 41, and a second noise reduction circuit 42:

The second reset circuit 14 is electrically connected to the first pull-down node PD1, the pull-up node PU, and the second voltage terminal V2. It controls conduction or disconnection between the pull-up node PU and the second voltage terminal V2 under the control of the potential of the first pull-down node PD1.

The third reset circuit 40 is electrically connected to the second pull-down node PD2, the pull-up node PU, and the second voltage terminal V2. It controls conduction or disconnection between the pull-up node PU and the second voltage terminal V2 under the control of the potential of the second pull-down node PD2.

The first noise reduction circuit 41 is electrically connected to the first noise reduction control terminal Ct1, the first pull-down node PD1, and the second voltage terminal V2. It controls conduction or disconnection between the first pull-down node PD1 and the second voltage terminal V2 under the control of the first noise reduction control signal provided by the first noise reduction control terminal Ct1.

The second noise reduction circuit 42 is electrically connected to the second noise reduction control terminal Ct2, the second pull-down node PD2, and the second voltage terminal V2. It controls conduction or disconnection between the second pull-down node PD2 and the second voltage terminal V2 under the control of the second noise reduction control signal provided by the second noise reduction control terminal Ct2.

In at least one embodiment of the present disclosure, the driver circuit may further include a second pull-down noise reduction circuit:

The second pull-down noise reduction circuit is electrically connected to the second pull-down node, the pull-up node, and the second voltage terminal. It inputs the second voltage signal provided by the second voltage terminal to the pull-up node under the control of the potential of the second pull-down node.

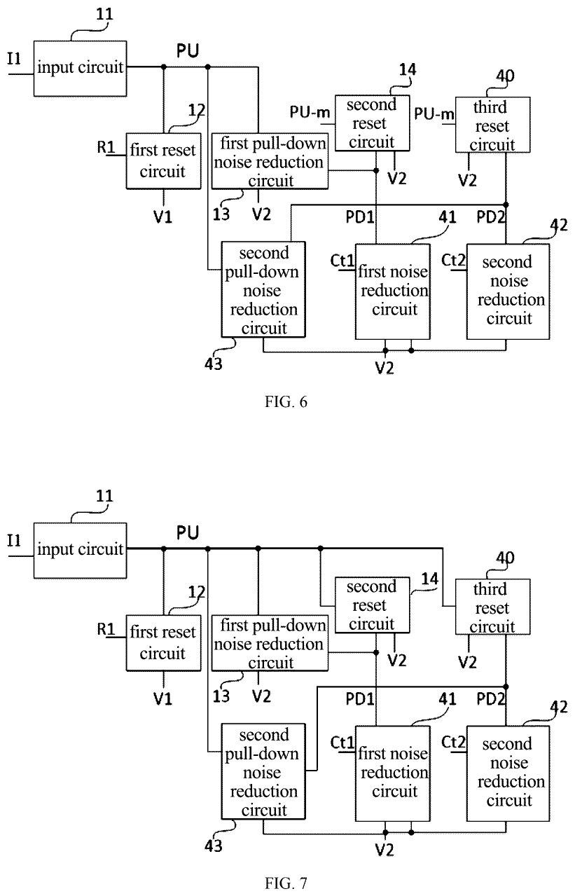

As shown in FIG. 6, based on at least one embodiment of the driver circuit shown in FIG. 4, the driver circuit may further include a second pull-down noise reduction circuit 43:

The second pull-down noise reduction circuit 43 is electrically connected to the second pull-down node PD2, the pull-up node PU, and the second voltage terminal V2. It inputs the second voltage signal provided by the second voltage terminal V2 to the pull-up node PU under the control of the potential of the second pull-down node PD2.

As shown in FIG. 7, based on at least one embodiment of the driving circuit shown in FIG. 5, the driving circuit may further include a second pull-down noise reduction circuit 43. The second pull-down noise reduction circuit 43 is electrically connected to a second pull-down node PD2, the pull-up node PU, and the second voltage terminal V2, respectively. The second pull-down noise reduction circuit 43 is used to input the second voltage signal provided by the second voltage terminal V2 to the pull-up node PU under the control of the second pull-down node PD2.

Optionally, the first reset circuit includes a first transistor.

The gate of the first transistor is electrically connected to the first reset terminal. The first electrode of the first transistor is electrically connected to the pull-up node, and the second electrode is electrically connected to the first voltage terminal.

In at least one embodiment disclosed herein, the channel length of the first transistor is greater than a channel length threshold value, and the width-to-length ratio of the channel is less than a width-to-length ratio threshold value.

At least one embodiment may reduce the impact of surge current for the first transistor by increasing its channel length and reducing its width-to-length ratio. Specifically, when the overlapping area between the gate metal layer and the source-drain metal layer of the first transistor remains unchanged, the parasitic capacitance between the gate and source-drain electrodes remains constant without affecting the bootstrap pull-up of the potential of the pull-up node. At the same time, this minimizes the leakage current of the first transistor. Further reducing the width-to-length ratio of the first transistor reduces the surge current, improves the performance of the first transistor, and minimizes performance drift.

Optionally, the second reset circuit includes a second transistor. The gate of the second transistor is electrically connected to the first pull-down node. The first electrode of the second transistor is electrically connected to the pull-up node of the adjacent mth previous stage driver circuit, and the second electrode is electrically connected to the second voltage terminal.

Optionally, the second reset circuit includes a second transistor.

The gate of the second transistor is electrically connected to the first pull-down node. Its first electrode is electrically connected to the pull-up node, while the second electrode connects to the second voltage terminal.

Optionally, the third reset circuit includes a third transistor.

The gate of the third transistor is electrically connected to the second pull-down node. Its first electrode is electrically connected to the pull-up node of the adjacent mth previous stage driver circuit, while the second electrode connects to the second voltage terminal.

Optionally, the third reset circuit includes a third transistor.

The gate of the third transistor is electrically connected to the second pull-down node. Its first electrode is electrically connected to the pull-up node, while the second electrode connects to the second voltage terminal.

Optionally, the first noise reduction circuit includes a fourth transistor. The gate of the fourth transistor is electrically connected to the first noise reduction control terminal. Its first electrode connects to the first pull-down node, and the second electrode connects to the second voltage terminal.

Optionally, the second noise reduction circuit includes a fifth transistor. The gate of the fifth transistor is electrically connected to the second noise reduction control terminal. Its first electrode connects to the second pull-down node, and its second electrode connects to the second voltage terminal.

In at least one embodiment disclosed herein, the driving circuit also includes a driving signal output terminal and a driver reset circuit. The driver reset circuit is electrically connected to the pull-down node, the driving signal output terminal, and the first voltage terminal, respectively. Under control of the potential of the pull-down node, it controls whether conduction is established or disconnected between the driving signal output terminal and the first voltage terminal.

Alternatively:

The drive reset circuit is electrically connected to the pull-down node, the driving signal output terminal, and the third voltage terminal, respectively. Under the control of the pull-down node's potential, it controls conduction or disconnection between the driving signal output terminal and the third voltage terminal. The first voltage terminal and the third voltage terminal are different voltage terminals.

In implementation, the driving circuit optionally includes a driver reset circuit that, under control of the pull-down node's potential, controls conduction between the driving signal output terminal and the first or third voltage terminal to reset the driving signal provided from the output terminal.

In at least one embodiment, the third voltage terminal may be a first low voltage terminal but is not limited thereto. Optionally, the driver reset circuit comprises a sixth transistor and a seventh transistor, and the pull-down node includes a first pull-down node and a second pull-down node.

The gate of the sixth transistor is electrically connected to the first pull-down node. The first electrode of the sixth transistor is electrically connected to the driving signal output terminal, and the second electrode is connected to the first voltage terminal or the third voltage terminal.

The gate of the seventh transistor is electrically connected to the second pull-down node. The first electrode of the seventh transistor connects to the driving signal output terminal, and the second electrode is connected to the first voltage terminal or the third voltage terminal.

In at least one embodiment, the driving circuit further includes a carry-out terminal, a pull-up node control circuit, a pull-down node control circuit, a carry-output circuit, a driving output circuit, and an energy storage circuit:

The pull-up node control circuit is electrically connected to the pull-up node, the frame reset terminal, and the second voltage terminal. It uses the frame reset signal provided by the frame reset terminal to control whether conduction is established or interrupted between the pull-up node and the second voltage terminal.

The pull-down node control circuit is electrically connected to the pull-down node, the control voltage terminal, and the second voltage terminal. It depends on the control voltage provided by the control voltage terminal to control the potential of the pull-down node.

The drive output circuit is electrically connected to the pull-up node, the first clock signal terminal, and the driving signal output terminal. It outputs the first clock signal provided by the clock terminal based on control from the pull-up node potential to the drive output terminal.

The carry-output circuit is electronically linked with the pull-up node, pull-down node, a second clock signal terminal, the carry-out terminal, and the second voltage terminal. It uses the potential at the pull-up node to decide connecting or delivering clock signals to the OC nodes [omitted for brevity pointers]. It lastly powers backup capacitors for excess compensation along reserve periods during stress cycling variations.

The carry output circuit is respectively connected to the pull-up node, the pull-down node, the carry output terminal, the second clock signal terminal, and the second voltage terminal. It controls, under the potential control of the pull-up node, the provision of the second clock signal from the second clock signal terminal to the carry output terminal. Under the potential control of the pull-down node, it controls whether conduction between the carry output terminal and the second voltage terminal is established or disconnected.

The energy storage circuit is respectively connected to the pull-up node and the driving signal output terminal, and is used for storing electrical energy.

In specific implementations, the driving circuit may also include a carry output terminal, a pull-up node control circuit, a pull-down node control circuit, a carry output circuit, a drive output circuit, and an energy storage circuit. The pull-up node control circuit, under the control of the frame reset signal, controls whether conduction between the pull-up node and the second voltage terminal is established or disconnected. The pull-down node control circuit, under the control of the control voltage, determines the potential of the pull-down node. The drive output circuit, under the potential control of the pull-up node, provides the first clock signal to the driving signal output terminal. The carry output circuit, under the potential control of the pull-up node, controls the provision of the second clock signal to the carry output terminal. Under the potential control of the pull-down node, it determines whether to establish or disconnect conduction between the carry output terminal and the second voltage terminal.

In at least one embodiment disclosed herein, the first clock signal terminal and the second clock signal terminal can be the same clock signal terminal that receives the same clock signal. Alternatively, the first clock signal terminal and the second clock signal terminal may be different clock signal terminals receiving different clock signals.

In specific implementations, between adjacent frame display times or before a frame display time, the frame reset terminal provides an effective frame reset signal to control conduction between the pull-up node and the second voltage terminal, thereby resetting the potential of the pull-up node.

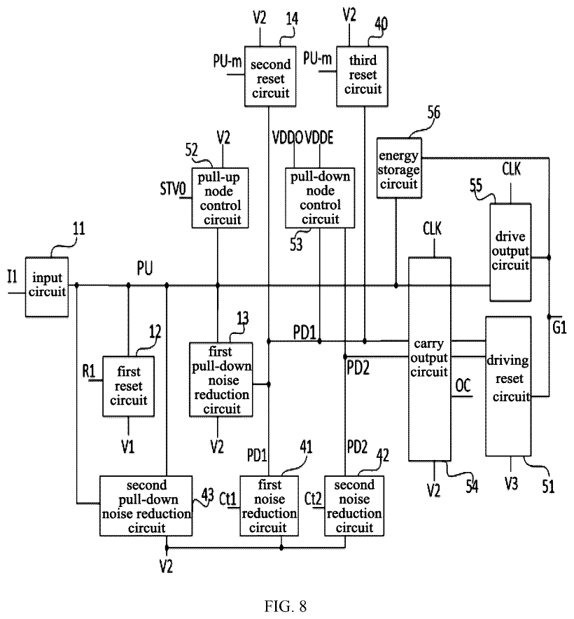

As shown in FIG. 8, based on at least one embodiment of the driving circuit shown in FIG. 6, this embodiment of the driving circuit further includes a driving signal output terminal G1, a driving reset circuit 51, a carry output terminal OC, a pull-up node control circuit 52, a pull-down node control circuit 53, a carry output circuit 54, a drive output circuit 55, and an energy storage circuit 56.

The driving reset circuit 51 is respectively connected to the first pull-down node PD1, the second pull-down node PD2, the driving signal output terminal G1, and the first voltage terminal V1, and is used to control, under the potential control of the first pull-down node PD1, whether conduction between the driving signal output terminal G1 and the first voltage terminal V1 is established or disconnected. Similarly, under the potential control of the second pull-down node PD2, it determines whether the driving signal output terminal G1 connects to the first voltage terminal V1.

The pull-up node control circuit 52 is connected to the pull-up node PU, the frame reset terminal STV0, and the second voltage terminal V2, and it controls, under the frame reset signal provided by the frame reset terminal STV0, whether conduction between the pull-up node PU and the second voltage terminal V2 is established or disconnected.

The pull-down node control circuit 53 is connected to the first pull-down node PD1, the second pull-down node PD2, the first control voltage terminal VDDO, and the second control voltage terminal VDDE, and it is used to determine, using the first control voltage provided by the first control voltage terminal VDDO, the potential of the first pull-down node PD1. Using the second control voltage provided by the second control voltage terminal VDDE, it determines the potential of the second pull-down node PD2.

The drive output circuit 55 is connected to the pull-up node PU, the clock signal terminal CLK, and the driving signal output terminal G1. Under the potential control of the pull-up node PU, it provides the clock signal from the clock signal terminal CLK to the driving signal output terminal G1.

The carry output circuit 54 is connected to the pull-up node PU, the first pull-down node PD1, the second pull-down node PD2, the carry output terminal OC, the clock signal terminal CLK, and the second voltage terminal V2. Under the potential control of the pull-up node PU, it controls the provision of the clock signal from the clock signal terminal CLK to the carry output terminal OC. Under the potential control of the first pull-down node PD1 or second pull-down node PD2, it determines whether conduction between the carry output terminal OC and the second voltage terminal V2 is established or disconnected.

The energy storage circuit 56 is respectively connected to the pull-up node PU and the driving signal output terminal G1 for storing electrical energy.

In at least one embodiment shown in FIG. 8, the first voltage terminal may be the first low voltage terminal VGL1, and the second voltage terminal may be the third low voltage terminal LVGL.

In at least one embodiment shown in FIG. 8, both the first clock signal terminal and the second clock signal terminal are clock signal terminals CLK.

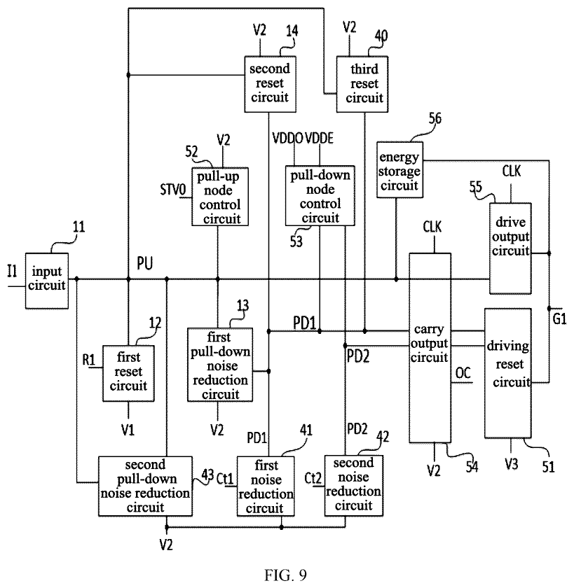

As shown in FIG. 9, based on at least one embodiment of the driving circuit shown in FIG. 7, this embodiment of the driving circuit further includes a driving signal output terminal G1, a driving reset circuit 51, a carry output terminal OC, a pull-up node control circuit 52, a pull-down node control circuit 53, a carry output circuit 54, a drive output circuit 55, and an energy storage circuit 56.

The driving reset circuit 51 is connected to the first pull-down node PD1, the second pull-down node PD2, the driving signal output terminal G1, and the third voltage terminal V3. Under the potential control of the first pull-down node PD1, it determines whether conduction between the driving signal output terminal G1 and the third voltage terminal V3 is established or disconnected. Similarly, under the potential control of the second pull-down node PD2, it determines whether the driving signal output terminal G1 connects to the third voltage terminal V3.

The pull-up node control circuit 52 is connected to the pull-up node PU, the frame reset terminal STV0, and the second voltage terminal V2. Under the control of the frame reset signal provided by the frame reset terminal STV0, it determines whether conduction exists between the pull-up node PU and the second voltage terminal V2.

The pull-down node control circuit 53 is respectively connected to the first pull-down node PD1, the second pull-down node PD2, the first control voltage terminal VDDO, and the second control voltage terminal VDDE. Based on the first control voltage provided by VDDO, it determines the potential of PD1; based on the second control voltage provided by VDDE, it determines the potential of PD2.

The drive output circuit 55 is connected to the pull-up node PU, the clock signal terminal CLK, and the driving signal output terminal G1 to forward the clock signal from CLK to G1 under control of PU's potential.

The carry output circuit 54 is connected to the pull-up node PU, the first pull-down node PD1, the second pull-down node PD2, the carry output terminal OC, the clock signal terminal CLK, and the second voltage terminal V2. Under the potential control of the pull-up node PU, it provides the clock signal from the clock signal terminal CLK to the carry output terminal OC. Under the potential control of the first pull-down node PD1 and the second pull-down node PD2, it determines whether conduction between the carry output terminal OC and the second voltage terminal V2 is established or disconnected.

The energy storage circuit 56 is connected to the pull-up node PU and the driving signal output terminal G1 to store electrical energy.

In at least one embodiment shown in FIG. 9, the first voltage terminal may be defined as a second low voltage terminal VGL2, the second voltage terminal may be defined as a third low voltage terminal LVGL, and the third voltage terminal may be defined as a first low voltage terminal VGL1.

In at least one embodiment shown in FIG. 9, the voltage value provided by the second low voltage terminal VGL2 is higher than the voltage value provided by the third low voltage terminal LVGL.

Optionally, the input circuit includes an eighth transistor, the pull-up node control circuit includes a ninth transistor, the pull-down nodes include the first pull-down node and the second pull-down node, and the voltage control terminals include the first control voltage terminal and the second control voltage terminal. The driving circuit further includes a second pull-down noise reduction circuit.

The pull-down node control circuit includes a tenth transistor and a twelfth transistor; the first pull-down noise reduction circuit includes an eleventh transistor, the second pull-down noise reduction circuit includes a thirteenth transistor, the drive output circuit includes a fourteenth transistor, the carry output circuit includes a fifteenth transistor, a sixteenth transistor, and a seventeenth transistor, and the energy storage circuit includes a storage capacitor.

The gate and first electrode of the eighth transistor are both connected to the input terminal, and the second electrode is connected to the pull-up node.

The gate of the ninth transistor is connected to the frame reset terminal, the first electrode is connected to the pull-up node, and the second electrode is connected to the second voltage terminal.

The gate and first electrode of the tenth transistor are both connected to the first control voltage terminal, and the second electrode is connected to the first pull-down node PD1.

The gate of the eleventh transistor is connected to the pull-up node, the first electrode is connected to the first pull-down node PD1, and the second electrode is connected to the second voltage terminal.

The gate and first electrode of the twelfth transistor are both connected to the second control voltage terminal, and the second electrode is connected to the second pull-down node PD2.

The gate of the thirteenth transistor is connected to the pull-up node, the first electrode is connected to the second pull-down node PD2, and the second electrode is connected to the second voltage terminal.

The gate of the fourteenth transistor is connected to the pull-up node, the first electrode is connected to the clock signal terminal CLK, and the second electrode is connected to the driving signal output terminal G1.

The gate of the fifteenth transistor is connected to the pull-up node, the first electrode is connected to the second clock signal terminal, and the second electrode is connected to the carry output terminal OC.

The gate of the sixteenth transistor is connected to the first pull-down node PD1, the first electrode is connected to the carry output terminal OC, and the second electrode is connected to the second voltage terminal.

The gate of the seventeenth transistor is connected to the second pull-down node PD2, the first electrode is connected to the carry output terminal OC, and the second electrode is connected to the second voltage terminal.

One terminal of the storage capacitor is connected to the pull-up node, and the other terminal is connected to the driving signal output terminal G1.

Optionally, the input terminal of the current stage driving circuit can be connected to the output terminal of the adjacent preceding m-stage driving circuit, and the first reset terminal of the current stage driving circuit can be connected to the output terminal of the adjacent subsequent m+1-stage driving circuit. The output terminal can be a carry output terminal or a driving signal output terminal.

In at least one embodiment disclosed herein, the input signal for the current stage driving circuit can be provided by the adjacent preceding m-stage driving circuits, and the first reset signal for the current stage driving circuit can be provided by the adjacent subsequent m+1-stage driving circuits. The input terminal of the foremost m-stage driving circuits in the driving module can be connected to an initial voltage terminal, which provides input signals to these foremost m-stage driving circuits.

For example, m can equal 4, but it is not limited to this value.

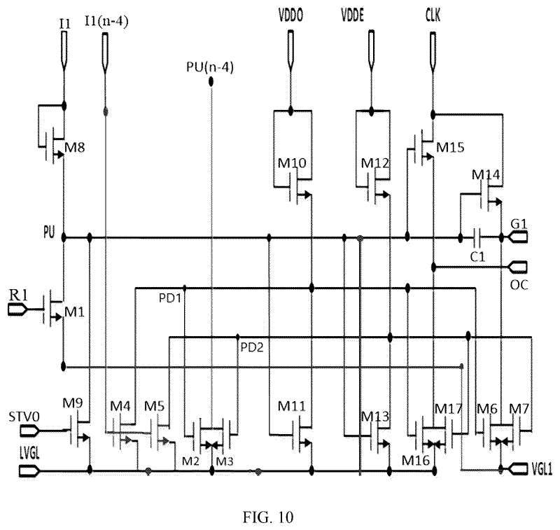

As shown in FIG. 10, based on at least one embodiment of the driving circuit shown in FIG. 8, the first reset circuit includes a first transistor M1:

The gate of the first transistor M1 is electrically connected to the first reset terminal R1. The source of the first transistor M1 is electrically connected to the pull-up node PU, and the drain is electrically connected to the first low voltage terminal VGL1.

The second reset circuit includes a second transistor M2:

The gate of the second transistor M2 is electrically connected to the first pull-down node PD1. The source of the second transistor M2 is electrically connected to the pull-up node PU(n−4) of the (n−4)th-stage driving circuit, and the drain is electrically connected to the third low voltage terminal LVGL.

Optionally, at least one embodiment of the driving circuit further includes a third reset circuit, which includes a third transistor M3:

The gate of the third transistor M3 is electrically connected to the second pull-down node PD2. The source of the third transistor M3 is electrically connected to the pull-up node PU(n−4) of the (n−4)th-stage driving circuit, and the drain is electrically connected to the third low voltage terminal LVGL.

The first noise reduction circuit includes a fourth transistor M4:

The gate of the fourth transistor M4 is electrically connected to the input terminal I1(n−4) of the (n−4)th-stage driving circuit. The source of the fourth transistor M4 is electrically connected to the first pull-down node PD1, and the drain is electrically connected to the third low voltage terminal LVGL.

The second noise reduction circuit includes a fifth transistor M5:

The gate of the fifth transistor M5 is electrically connected to the input terminal I1(n−4) of the (n−4)th-stage driving circuit. The source of the fifth transistor M5 is electrically connected to the second pull-down node PD2, and the drain is electrically connected to the third low voltage terminal LVGL.

The drive reset circuit includes a sixth transistor M6 and a seventh transistor M7. The pull-down nodes include the first pull-down node PD1 and the second pull-down node PD2:

The gate of the sixth transistor M6 is electrically connected to the first pull-down node PD1. The source of the sixth transistor M6 is electrically connected to the driving signal output terminal G1, and the drain is electrically connected to the first low voltage terminal VGL1.

The gate of the seventh transistor M7 is electrically connected to the second pull-down node PD2. The source of the seventh transistor M7 is electrically connected to the driving signal output terminal G1, and the drain is electrically connected to the first low voltage terminal VGL1.

The input circuit includes an eighth transistor M8, and the pull-up node control circuit includes a ninth transistor M9. The voltage control terminals include the first control voltage terminal VDDO and the second control voltage terminal VDDE. The pull-down node control circuit includes a tenth transistor M10, an eleventh transistor M11, a twelfth transistor M12, and a thirteenth transistor M13. The drive output circuit includes a fourteenth transistor M14. The carry output circuit includes a fifteenth transistor M15, a sixteenth transistor M16, and a seventeenth transistor M17. The storage circuit includes a storage capacitor C1:

The gate and the source of the eighth transistor M8 are both electrically connected to the input terminal I1, and the drain is electrically connected to the pull-up node PU. Optionally, the gate and the source of the eighth transistor M8 can also separately connect to respective signals. For example, the gate of the eighth transistor M8 can be electrically connected to the carry output terminal of the preceding-stage driving circuit, and the source of the eighth transistor M8 can connect to an effective voltage level signal (for instance, when transistors connected to the pull-up node PU are n-type transistors in the driving circuit, the effective voltage signal is a high-level signal; when the transistors are p-type transistors, the effective voltage signal can be a low-level signal). Alternatively, the gate of the eighth transistor M8 can be electrically connected to the carry output terminal of the preceding-stage driving circuit, and the source of the eighth transistor M8 can be connected to the driving signal output terminal of the preceding-stage driving circuit. Specifically, the preceding-stage driving circuit can be the adjacent ith-stage driving circuit, where i is a positive integer and not limited herein.

The gate of the ninth transistor M9 is electrically connected to the frame reset terminal STV0. The source of the ninth transistor M9 is electrically connected to the pull-up node PU, and the drain is electrically connected to the third low voltage terminal LVGL. The ninth transistor M9 is used to reset the pull-up node PU before the start of a frame or between adjacent frames.

The gate and source of the tenth transistor M10 are both electrically connected to the first control voltage terminal VDDO, and the drain is electrically connected to the first pull-down node PD1.

The gate of the eleventh transistor M11 is electrically connected to the pull-up node PU. The source of the eleventh transistor M11 is electrically connected to the first pull-down node PD1, and the drain is electrically connected to the third low voltage terminal LVGL.

The gate and source of the twelfth transistor M12 are both electrically connected to the second control voltage terminal VDDE, and the drain is electrically connected to the second pull-down node PD2.

The gate of the thirteenth transistor M13 is electrically connected to the pull-up node PU. The source of the thirteenth transistor M13 is electrically connected to the second pull-down node PD2, and the drain is electrically connected to the third low voltage terminal LVGL.

The gate of the fourteenth transistor M14 is electrically connected to the pull-up node PU. The source of the fourteenth transistor M14 is connected to the clock signal terminal CLK, and the drain is connected to the driving signal output terminal G1.

The gate of the fifteenth transistor M15 is electrically connected to the pull-up node PU. The source of the fifteenth transistor M15 connects to the clock signal terminal CLK, and the drain connects to the carry output terminal OC.

The gate of the sixteenth transistor M16 is electrically connected to the first pull-down node PD1. The source of the sixteenth transistor M16 connects to the carry output terminal OC, and the drain is connected to the third low voltage terminal LVGL.

The gate of the seventeenth transistor M17 is electrically connected to the second pull-down node PD2. The source of the seventeenth transistor M17 connects to the carry output terminal OC, and the drain is connected to the third low voltage terminal LVGL.

One terminal of the storage capacitor C1 is electrically connected to the pull-up node PU, and the other terminal is connected to the driving signal output terminal G1.

In at least one embodiment of the driving circuit shown in FIG. 10, all transistors are n-type transistors.

In at least one disclosed embodiment, the driving circuit could be an oxide-based driving circuit, but it is not restricted to this. In practical operations, the driving circuit may also be a-Si (amorphous silicon)-based driving circuit. At least one embodiment disclosed here is applicable to improving the charging rate of a-Si display products, such as gaming display products.

In at least one embodiment of the driving circuit in FIG. 10, the driving circuit is the nth-stage driving circuit, where n is a positive integer.

In at least one embodiment of the driving circuit in FIG. 10, the first voltage terminal is the first low voltage terminal VGL1, and the second voltage terminal is the third low voltage terminal LVGL.

The voltage value provided by the first low voltage terminal VGL1 can be −10V, and the voltage value provided by the third low voltage terminal LVGL can be −15V.

In at least one embodiment of the driving circuit shown in FIG. 10, the input terminal I1 can connect to the carry output terminals of the preceding four-stage driving circuits. The first reset terminal R1 can connect to the carry output terminals of the subsequent five-stage driving circuits.

During operation of at least one embodiment of the driving circuit in FIG. 10, the high voltage value VGH of the clock signal provided by the clock signal terminal can decrease from 32V to 30V, and the drain voltage of M 2 can increase from −15V to −10V. When the potential of the pull-up node PU is at a high voltage, the absolute value of the potential difference between the source and drain of M1 decreases, which enhances the voltage resistance of M1, prevents characteristic drift of M1 under large Vds stress, improves the reliability of the display product, and avoids reducing the output capability of the driving module.

In at least one disclosed embodiment, the low-voltage value of the clock signal provided by the clock signal terminal can be equal to the third low voltage value, which is the voltage value of the third low voltage signal provided by the third low voltage terminal LVGL.

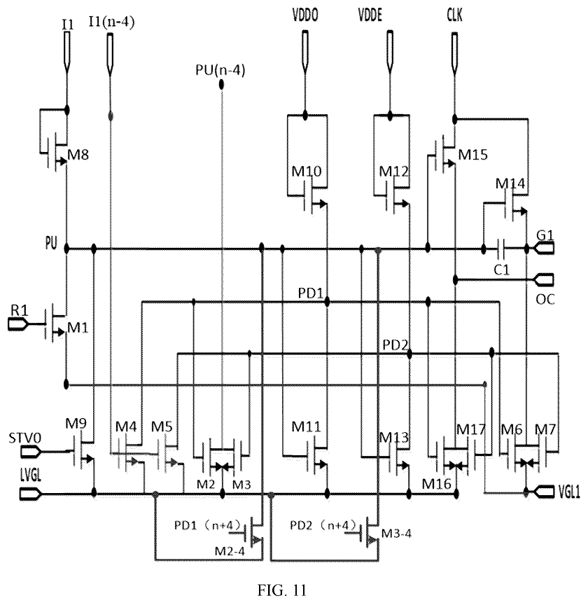

As shown in FIG. 11, based on at least one embodiment of the driving circuit depicted in FIG. 10, the second reset circuit and the third reset circuit of the (n+4)th-stage driving circuit are also illustrated. The second reset circuit of the (n+4)th-stage driving circuit includes a second transistor M2-4, while the third reset circuit of the (n+4)th-stage driving circuit includes a third transistor M3-4;

The gate of M2-4 is electrically connected to the first pull-down node PD1(n+4) of the (n+4)th-stage driving circuit, its source is electrically connected to the pull-up node PU, and its drain is electrically connected to the third low voltage terminal LVGL;

The gate of M3-4 is electrically connected to the second pull-down node PD2(n+4) of the (n+4)th-stage driving circuit, its source is electrically connected to the pull-up node PU, and its drain is electrically connected to the third low voltage terminal LVGL.

In at least one embodiment of the driving circuit shown in FIG. 11, during operation, the potential of the pull-up node PU is reset under the control of the potential of the first pull-down node PD1(n+4) and the second pull-down node PD2(n+4) in the (n+4)th-stage driving circuit.

In at least one embodiment of the driving circuit shown in FIG. 11, the source of M2 is electrically connected to the pull-up node PU(n−4) of the (n−4)th-stage driving circuit, and M3's source is similarly connected to PU(n−4). The gates of M4 and M5 are both electrically connected to the input terminal I1(n−4) of the (n−4)th-stage driving circuit, that is, M2, M3, M4, and M5 are all connected to the same stage of the driving circuit, as indicated by this representation of the (n−4)th-stage driving circuit. This ensures that when the potential of the pull-up node PU in the (n−4)th-stage driving circuit reaches a high voltage, I1(n−4) controls the conduction of M4 and M5. Signals provided by LVGL are transmitted to the first pull-down node PD1 and the second pull-down node PD2, causing these nodes to control M2 and M3 in the nth-stage driving circuit to remain in an off state. This prevents M2 and M3 from turning on and inadvertently lowering the potential of the pull-up node PU(n−4) in the (n−4)th-stage driving circuit.

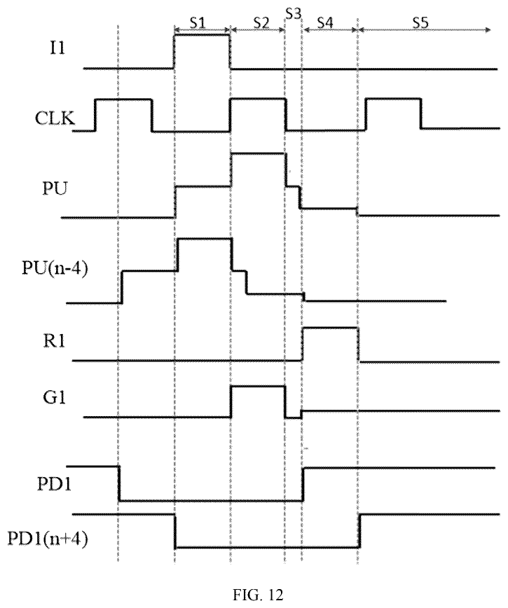

As shown in FIG. 12, the operational cycle for at least one embodiment of the driving circuit shown in FIG. 11 may include five sequential stages: S1, S2, S3, S4, and S5;

In the first stage S1, I1 provides a high voltage signal, and CLK provides a low voltage signal. M8 turns on, causing the potential of PU to increase for the first time. M14 and M15 turn on, and OC and G1 output low voltage signals. The first stage S1 lasts for 4 H, where 1 H represents the charging time for one row;

In the second stage S2, CLK provides a high voltage signal, and I1 provides a low voltage signal. Both M14 and M15 remain on, and OC and G1 output high voltage signals. Due to the bootstrap effect of C1, the potential of PU increases for the second time;

In the third stage S3, CLK provides a low voltage signal, and I1 provides a low voltage signal. M14 and M15 remain on, and OC and G1 output low voltage signals. The potential of PU decreases for the first time. The third stage S3 lasts for 1 H;

In the fourth stage S4, I1 provides a low voltage signal, CLK provides a low voltage signal, and R1 provides a high voltage signal. M1 turns on, establishing conduction between PU and VGL1, and the potential of PU decreases for the second time. The fourth stage S4 is the reset stage, during which R1 can connect to the carry output terminal of the subsequent-stage driving circuit;

In the fifth stage S5, I1 provides a low voltage signal, and PD1(n+4) has a high voltage. M2-4 turns on, establishing conduction between PU and LVGL, and the potential of PU decreases for the third time.

As shown in FIG. 12, during the third stage S3, G1 outputs a low voltage signal, and the voltage value of the signal equals the third low voltage value. This third low voltage value corresponds to the voltage value of the third voltage signal provided by LVGL.

During the operation of at least one embodiment of the driving circuit shown in FIG. 11, VDDO and VDDE alternately output high voltage signals to ensure that PD1 and PD2 alternate in functionality.

As shown in FIG. 12, during the fourth stage S4, the potential of PD1 becomes high, M2 turns on, and there is conduction between PU(n−4) and LVGL.

In at least one embodiment of the driving circuit shown in FIG. 11, a method is employed that pre-lowers the potential of the pull-down node and delays noise reduction for the pull-up node. By lowering the potential of the pull-down node 4 H earlier, the duration for which the pull-down node remains at a low level is extended by an additional 4 H. Noise reduction for the pull-up node in the current-stage driving circuit is achieved via the pull-down nodes in the (n+4)th-stage driving circuit by activating M2-4 or M3-4.

In at least one embodiment disclosed herein, M1 reduces the potential of PU using VGL1, while M2-4 or M3-4 lower the potential of PU via LVGL. After the period during which PU remains at a high level ends, M1 first lowers the potential of PU to a first low voltage value (corresponding to the first low voltage signal) or a second low voltage value (corresponding to the second low voltage signal). Then, M2-4 or M3-4 further reduce the potential of PU to a third low voltage value. When M1 is off, the absolute value of the drain-to-source voltage (Vds) across M1 decreases, reducing the characteristic drift of M1. When M1 is on, the voltage difference across its electrodes decreases, reducing instantaneous current.

At least one embodiment does not require additional GOA (Gate On Array) devices. Instead, adjustments to the original signal connection method enable source-drain voltage reduction for M1.

In at least one disclosed embodiment, M1 and M2-4 will not turn on simultaneously, nor will M1 and M3-4. This prevents short circuits caused by simultaneous activation of these transistors.

In practical operation, if M1 and M2-4 or M1 and M3-4 turn on at the same time, PU would simultaneously connect to both VGL1 and LVGL, potentially causing a short circuit. At least one embodiment avoids this by ensuring that mutual exclusion conditions prevent such simultaneous activation.

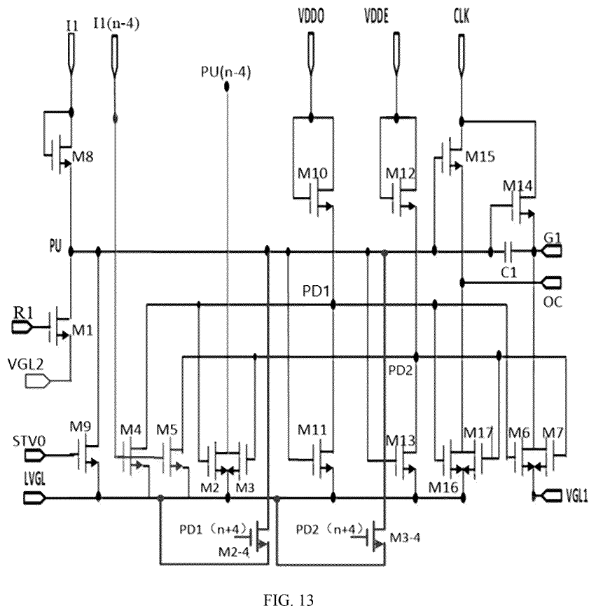

The distinction between the embodiment shown in FIG. 13 and the embodiment shown in FIG. 11 lies in the connection of M1's drain to the second low voltage terminal VGL2.

In at least one embodiment of the driving circuit shown in FIG. 13, the first low voltage terminal VGL1 provides a first low voltage signal with a value of −10V, the second low voltage terminal VGL2 provides a second low voltage signal with a value of −8V, and the third low voltage terminal LVGL provides a third low voltage signal with a value of −15V.

In this embodiment, connecting M1's drain to VGL2 reduces the load on the first low voltage terminal VGL1 and improves the reset performance of the driving signal output terminal G1.

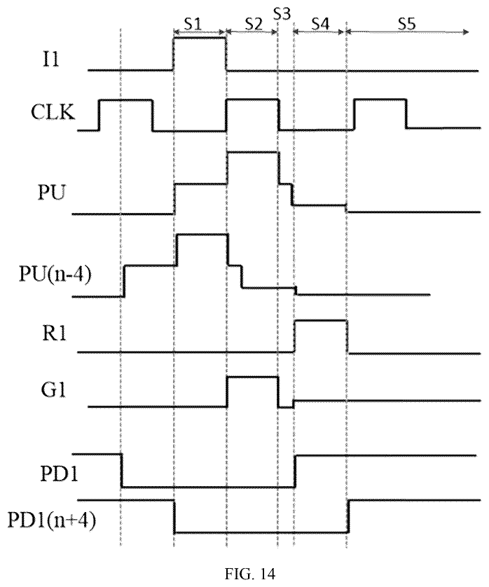

As shown in FIG. 14, during the operation of at least one embodiment of the driving circuit shown in FIG. 13, the operational cycle may similarly include Stages S1 through S5 as described previously. Specific differences include:

In Stage S4, conduction is established between PU and VGL2 when M1 turns on, causing the second drop in PU's potential.

As shown in FIG. 14, during Stage S3, G1 outputs a low voltage signal equal to the third low voltage value, matching the third voltage signal provided by LVGL.

In at least one embodiment of the driving circuit shown in FIG. 13, VGL2 serves as an independent low voltage terminal. The voltage of the second low voltage signal provided by VGL2 can be adjusted to match M1's voltage tolerance, while maintaining compatibility with M11, M2, and M3. Furthermore, since VGL1 provides a low voltage signal to G1 and does not directly connect to M1, it minimizes any impact on the effective display area.

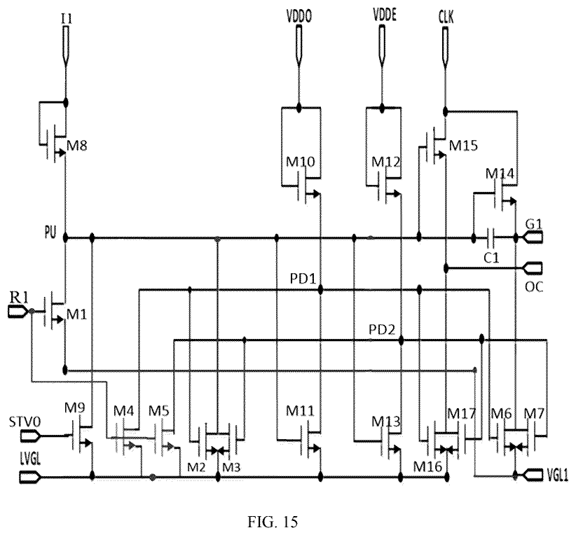

As shown in FIG. 15, based on at least one embodiment of the driving circuit shown in FIG. 8, the first reset circuit includes a first transistor M1;

The gate of the first transistor M1 is electrically connected to the first reset terminal R1, the source of the first transistor M1 is electrically connected to the pull-up node PU, and the drain of the first transistor M1 is electrically connected to the first low voltage terminal VGL1.

The second reset circuit includes a second transistor M2;

The gate of the second transistor M2 is electrically connected to the first pull-down node PD1, the source of the second transistor M2 is electrically connected to the pull-up node PU, and the drain of the second transistor M2 is electrically connected to the third low voltage terminal LVGL.

The third reset circuit includes a third transistor M3;

The gate of the third transistor M3 is electrically connected to the second pull-down node PD2, the source of the third transistor M3 is electrically connected to the pull-up node PU, and the drain of the third transistor M3 is electrically connected to the third low voltage terminal LVGL.

The first noise reduction circuit includes a fourth transistor M4;

The gate of the fourth transistor M4 is electrically connected to the first reset terminal R1, the source of the fourth transistor M4 is electrically connected to the first pull-down node PD1, and the drain of the fourth transistor M4 is electrically connected to the third low voltage terminal LVGL.

The second noise reduction circuit includes a fifth transistor M5;

The gate of the fifth transistor M5 is electrically connected to the first reset terminal R1, the source of the fifth transistor M5 is electrically connected to the second pull-down node PD2, and the drain of the fifth transistor M5 is electrically connected to the third low voltage terminal LVGL.

The drive reset circuit includes a sixth transistor M6 and a seventh transistor M7, with the pull-down nodes including the first pull-down node PD1 and the second pull-down node PD2;

The gate of the sixth transistor M6 is electrically connected to the first pull-down node PD1, the source of the sixth transistor M6 is electrically connected to the driving signal output terminal G1, and the drain of the sixth transistor M6 is electrically connected to the first low voltage terminal VGL1.

The gate of the seventh transistor M7 is electrically connected to the second pull-down node PD2, the source of the seventh transistor M7 is electrically connected to the driving signal output terminal G1, and the drain of the seventh transistor M7 is electrically connected to the first low voltage terminal VGL1.

The input circuit includes an eighth transistor M8, and the pull-up node control circuit includes a ninth transistor M9. The control voltage terminals include the first control voltage terminal VDDO and the second control voltage terminal VDDE. The pull-down node control circuit includes a tenth transistor M10, an eleventh transistor M11, a twelfth transistor M12, and a thirteenth transistor M13. The drive output circuit includes a fourteenth transistor M14. The carry output circuit includes a fifteenth transistor M15, a sixteenth transistor M16, and a seventeenth transistor M17. The storage circuit includes a storage capacitor C1;

The gate and source of the eighth transistor M8 are both electrically connected to the input terminal I1, and the drain is electrically connected to the pull-up node PU.

The gate of the ninth transistor M9 is electrically connected to the frame reset terminal STV0, the source of the ninth transistor M9 is electrically connected to the pull-up node PU, and the drain is electrically connected to the third low voltage terminal LVGL.

The gate and source of the tenth transistor M10 are both electrically connected to the first control voltage terminal VDDO, and its drain is electrically connected to the first pull-down node PD1.

The gate of the eleventh transistor M11 is electrically connected to the pull-up node PU, the source of the eleventh transistor M11 is electrically connected to the first pull-down node PD1, and the drain is electrically connected to the third low voltage terminal LVGL.

The gate and source of the twelfth transistor M12 are both electrically connected to the second control voltage terminal VDDE, and its drain is electrically connected to the second pull-down node PD2.

The gate of the thirteenth transistor M13 is electrically connected to the pull-up node PU, the source of the thirteenth transistor M13 is electrically connected to the second pull-down node PD2, and its drain is electrically connected to the third low voltage terminal LVGL.

The gate of the fourteenth transistor M14 is electrically connected to the pull-up node PU, the source of the fourteenth transistor M14 is electrically connected to the clock signal terminal CLK, and the drain is electrically connected to the driving signal output terminal G1.

The gate of the fifteenth transistor M15 is electrically connected to the pull-up node PU, the source of the fifteenth transistor M15 is electrically connected to the clock signal terminal CLK, and the drain is electrically connected to the carry output terminal OC.

The gate of the sixteenth transistor M16 is electrically connected to the first pull-down node PD1, the source of the sixteenth transistor M16 is electrically connected to the carry output terminal OC, and the drain is electrically connected to the third low voltage terminal LVGL.

The gate of the seventeenth transistor M17 is electrically connected to the second pull-down node PD2, the source of the seventeenth transistor M17 is electrically connected to the carry output terminal OC, and the drain is electrically connected to the third low voltage terminal LVGL.

One terminal of the storage capacitor C1 is electrically connected to the pull-up node PU, and the other terminal is electrically connected to the driving signal output terminal G1.

In at least one embodiment of the driving circuit shown in FIG. 15, all transistors are n-type transistors.

In at least one embodiment of the driving circuit shown in FIG. 15, the driving circuit is an nth-stage driving circuit, where n is a positive integer.

In at least one embodiment of the driving circuit shown in FIG. 15, the first voltage terminal is the first low voltage terminal VGL1, and the second voltage terminal is the third low voltage terminal LVGL.

In at least one embodiment of the driving circuit shown in FIG. 15, the input terminal I1 can be electrically connected to the carry output terminals of the preceding four stages of driving circuits, while the first reset terminal R1 can be electrically connected to the carry output terminals of the subsequent five stages of driving circuits.

During operation of at least one embodiment of the driving circuit shown in FIG. 15, the voltage value of the first low voltage signal provided by VGL1 can be −8V, the voltage value of the third low voltage signal provided by LVGL can be −15V, and the high voltage value provided by CLK can be 32V. The drain voltage of M2 can change from −15V to −8V. When the potential of the pull-up node PU is at a high voltage, reducing the absolute value of the potential difference between the source and drain of M1 improves the voltage resistance of M1, prevents characteristic drift under high Vds stress, and enhances the reliability of display products.

In at least one embodiment of the driving circuit shown in FIG. 15 during operation, VDDO and VDDE alternately output high voltage signals to ensure that PD1 and PD2 alternate in functionality.

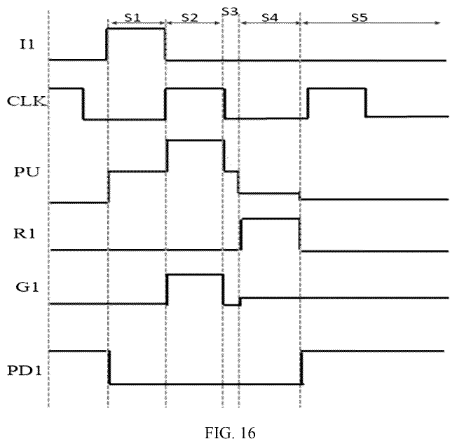

As shown in FIG. 16, during the operation of at least one embodiment of the driving circuit depicted in FIG. 15, the driving cycle may include five sequentially set stages: S1, S2, S3, S4, and S5;

In the first stage S1, I1 provides a high voltage signal, CLK provides a low voltage signal, M8 turns on, PU's potential rises for the first time, M14 and M15 both turn on, and G1 and OC output low voltage signals;

In the second stage S2, I1 provides a low voltage signal, CLK provides a high voltage signal, M14 and M15 both turn on, and G1 and OC output high voltage signals. Due to the bootstrap lifting effect of C1, the potential of PU rises for the second time;

In the third stage S3, I1 provides a low voltage signal, CLK provides a low voltage signal, M14 and M15 both turn on, and G1 and OC output low voltage signals. The potential of PU is lowered for the first time due to the effect of C1.

The third stage S3 can last for 1 H;

In the fourth stage S4, I1 provides a low voltage signal, CLK provides a low voltage signal, R1 provides a high voltage signal, and M1 turns on. Conduction between PU and VGL1 is established, and PU's potential is lowered for the second time;

In the fifth stage S5, I1 provides a low voltage signal, CLK provides a high voltage signal, R1 provides a low voltage signal, PD1 has a high voltage, M2 turns on, conduction between PU and LVGL is established, and PU's potential is lowered for the third time.

As shown in FIG. 16, during the third stage S3, G1 outputs a low voltage signal, and the voltage value of the low voltage signal output by G1 corresponds to the third low voltage value, which is equal to the voltage value of the third voltage signal provided by LVGL.

In at least one embodiment of the driving circuit shown in FIG. 15, the first reset terminal R1 controls the gate of M4 and the gate of M5, ensuring that when the pull-down node's potential is low, M2 and M3 cannot perform noise reduction on the potential of the pull-up node PU. After M1 finishes the noise reduction on PU's potential, M2 or M3 turns on again to perform noise reduction on PU's potential, controlling the conduction between PU and LVGL.

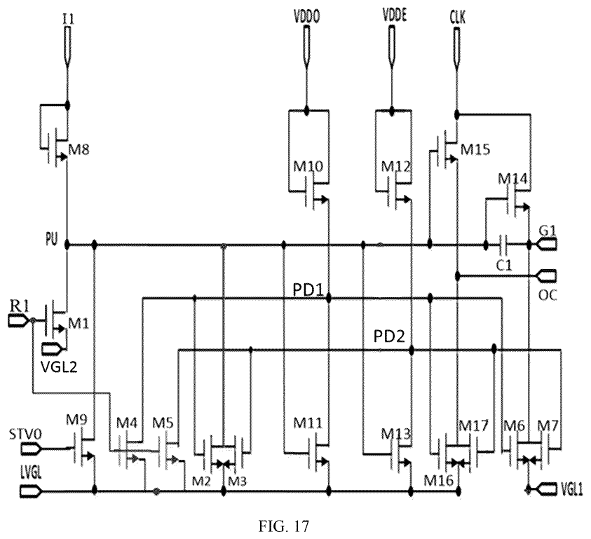

The distinction between at least one embodiment of the driving circuit in FIG. 17 and at least one embodiment of the driving circuit in FIG. 15 lies in the fact that the drain of M1 is connected to the second low voltage terminal VGL2.

In at least one embodiment of the driving circuit shown in FIG. 17, the voltage value of the first low voltage signal provided by the first low voltage terminal VGL1 can be −10V, the voltage value of the second low voltage signal provided by the second low voltage terminal VGL2 can be −8V, and the voltage value of the third low voltage signal provided by the third low voltage terminal LVGL can be −15V.

In at least one embodiment of the driving circuit shown in FIG. 17, M1's drain is connected to VGL2 to reduce the load on the first low voltage terminal VGL1 and improve the resetting effect on the driving signal output terminal G1.

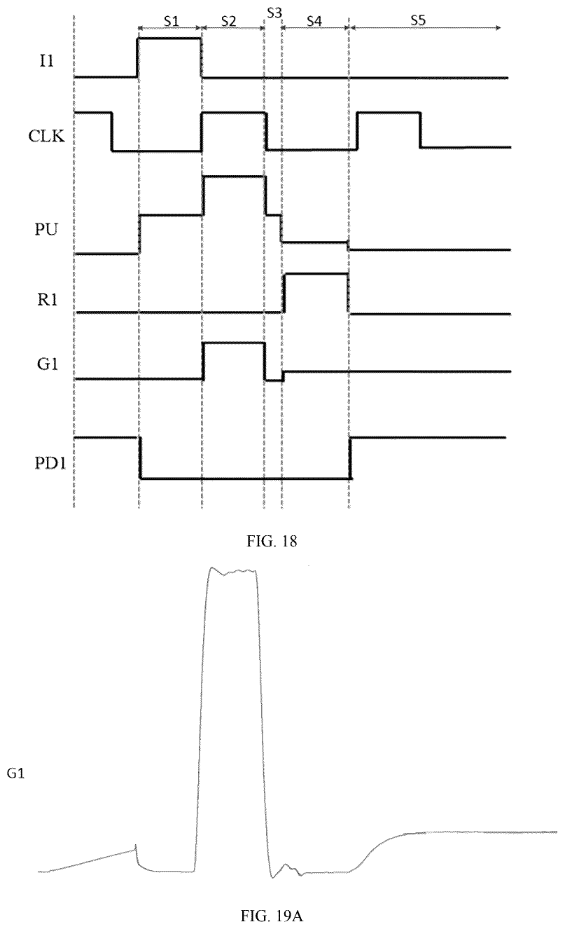

As shown in FIG. 18, during operation of at least one embodiment of the driving circuit depicted in FIG. 17, the driving cycle can again include five sequential stages: S1, S2, S3, S4, and S5;

In the first stage S1, I1 provides a high voltage signal, CLK provides a low voltage signal, M8 turns on, PU's potential rises for the first time, M14 and M15 both turn on, and G1 and OC output low voltage signals;

In the second stage S2, I1 provides a low voltage signal, CLK provides a high voltage signal, M14 and M15 both turn on, and G1 and OC output high voltage signals. Due to the bootstrap lifting effect of C1, the potential of PU rises for the second time;

In the third stage S3, I1 provides a low voltage signal, CLK provides a low voltage signal, M14 and M15 both turn on, and G1 and OC output low voltage signals. The potential of PU is lowered for the first time due to the effect of C1.

The third stage S3 can also last for 1 H;

In the fourth stage S4, I1 provides a low voltage signal, CLK provides a low voltage signal, R1 provides a high voltage signal, M1 turns on. Conduction between PU and VGL2 is established, and PU's potential is lowered for the second time;

In the fifth stage S5, I1 provides a low voltage signal, CLK provides a high voltage signal, R1 provides a low voltage signal, PD1 has a high voltage, M2 turns on, conduction between PU and LVGL is established, and PU's potential is lowered for the third time.

As shown in FIG. 18, during the third stage S3, G1 outputs a low voltage signal, and the voltage value of the low voltage signal output by G1 corresponds to the third low voltage value, which is equal to the voltage value of the third voltage signal provided by LVGL.

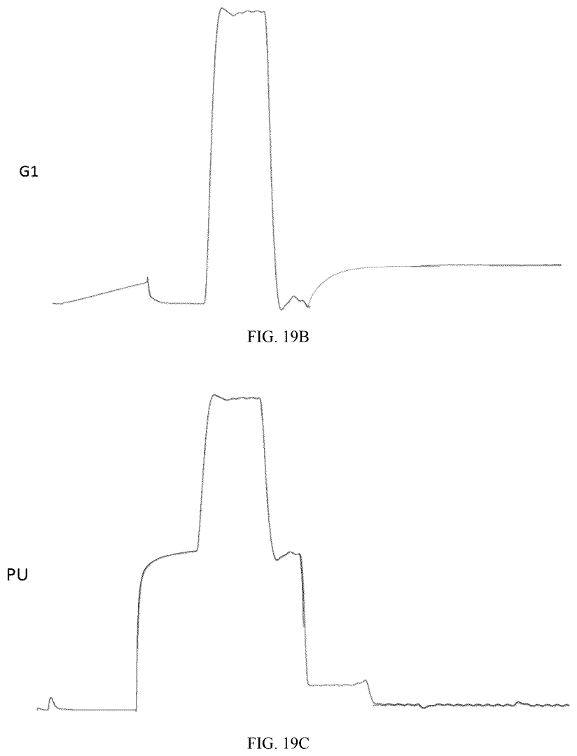

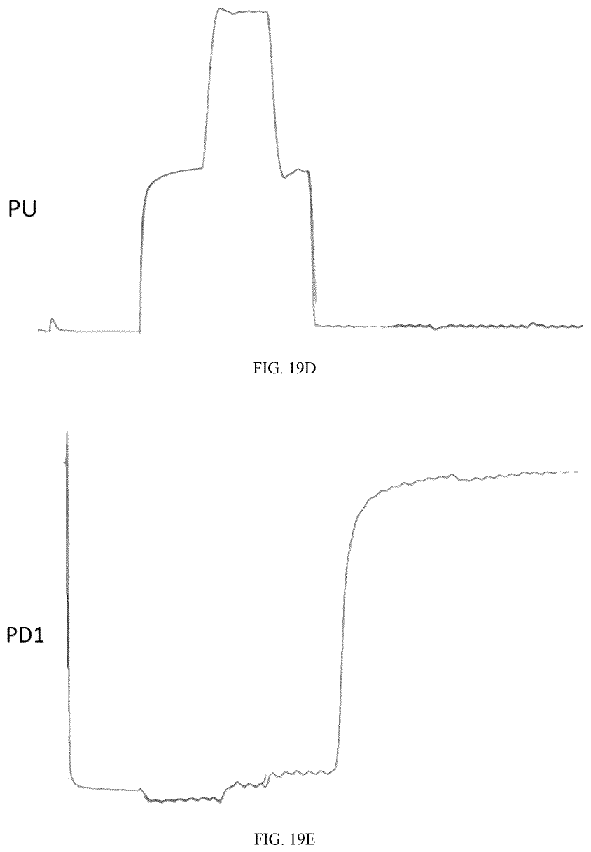

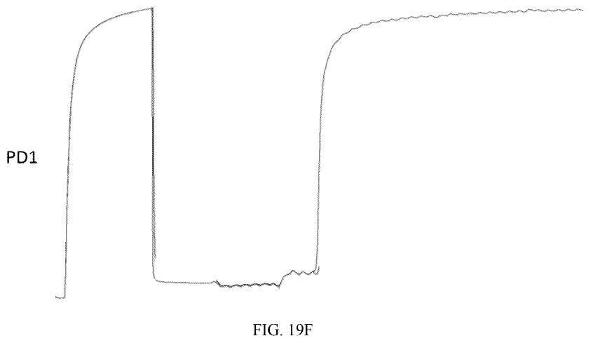

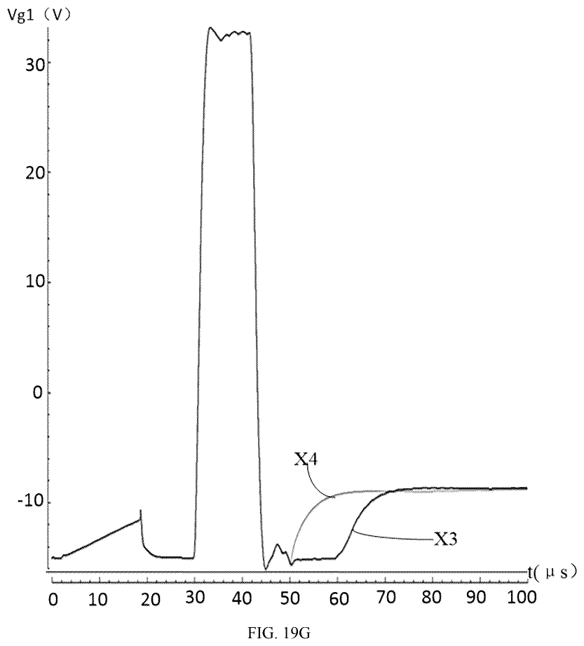

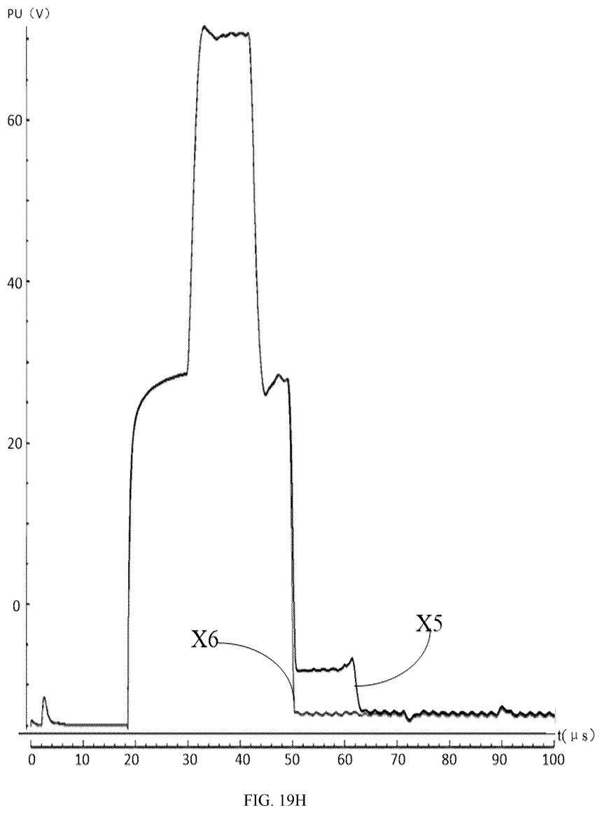

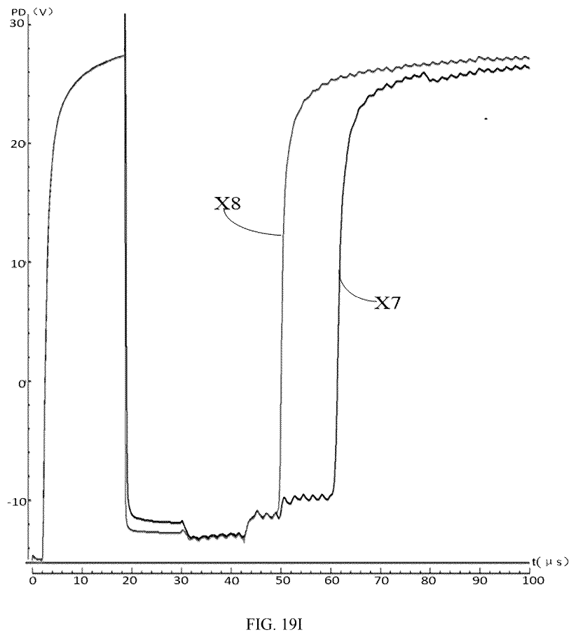

FIG. 19A shows the simulated waveform of the driving signal output by G1 during the operation of at least one embodiment of the driving circuit depicted in FIG. 15. FIG. 19B shows the simulated waveform of the driving signal output by G1 during the operation of the related driving circuit.

FIG. 19C shows the simulated waveform of the pull-up node PU during the operation of at least one embodiment of the driving circuit depicted in FIG. 15, and FIG. 19D shows the simulated waveform of the pull-up node PU during the operation of the related driving circuit.

FIG. 19E shows the simulated waveform of the first pull-down node PD1 during the operation of at least one embodiment of the driving circuit depicted in FIG. 15. FIG. 19F shows another simulated waveform of the first pull-down node PD1 during operation.

FIG. 19G shows the comparison between simulation waveforms X3 and X4 of the driving signal output by G1 during the operation of at least one embodiment of the driving circuit depicted in FIG. 15, alongside a related driving circuit.

FIG. 19H shows the comparison between simulation waveforms X5 and X6 of PU's potential during the operation of at least one embodiment of the driving circuit depicted in FIG. 15, alongside a related driving circuit.

FIG. 19I shows the comparison between simulation waveforms X7 and X8 of the potential of the pull-down node PD during the operation of at least one embodiment of the driving circuit depicted in FIG. 15, alongside a related driving circuit.

From FIGS. 19A, 19B, and 19G, it can be observed that during the operation of at least one embodiment of the driving circuit shown in FIG. 15, the duration of the low voltage maintained by the driving signal provided by G1 is longer, mainly because the duration during which PD's potential remains low is extended. M6 or M7 does not turn on, and G1 remains connected to LVGL, but this waveform does not affect the charging and discharging of the effective display area.

From FIGS. 19C, 19D, and 19H, it can be observed that during the operation of at least one embodiment of the driving circuit depicted in FIG. 15, after the bootstrap of PU's potential, it first reaches one low voltage, then drops to another lower voltage, with PU's potential being pulled down three times.

As shown in FIG. 19H, during the operation of at least one embodiment of the driving circuit depicted in FIG. 15, after the bootstrap of PU's potential, it first reaches a potential of about 70V, then drops to around 28V, then to about −15V, and finally further drops to around −7V.

In the related driving circuit, PU's potential is initially bootstrapped to approximately 70V, then drops to around 28V, and subsequently directly drops to −7V.

From FIGS. 19E, 19F, and 19I, it can be observed that during the operation of at least one embodiment of the driving circuit depicted in FIG. 15, the duration of the low-level state of PD1's potential has lengthened.

As shown in FIG. 19I, during the operation of at least one embodiment of the driving circuit shown in FIG. 15, the duration for which PD's potential remains below 0V is approximately 40 μs, while in the related driving circuit, this duration is about 30 μs.

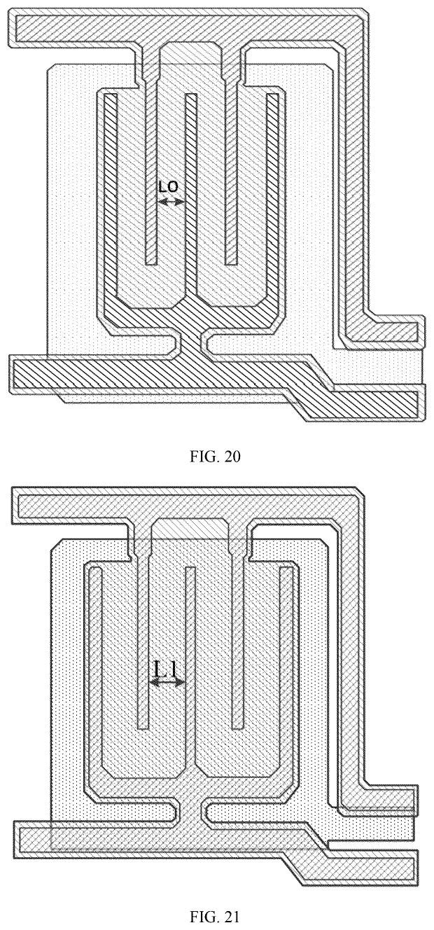

As shown in FIG. 20, in the related technology, the channel length L0 of M1 can be 8.5 μm;

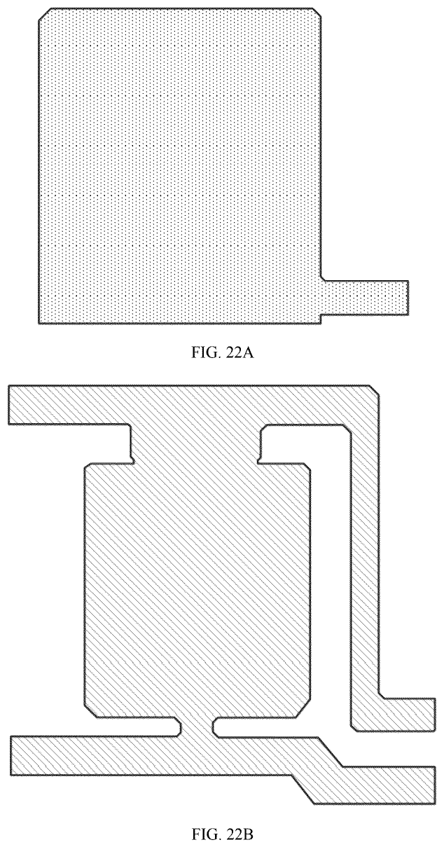

As shown in FIG. 21, in at least one embodiment disclosed herein, the channel length L1 of M1 can be greater than 8.5 μm, such as 10 μm, 11 μm, or 12 μm, etc., to reduce the channel width-to-length ratio of the first transistor M1 and lower the impact of M1's surge current.

In both the related technology and at least one disclosed embodiment, the channel width of the first transistor M1 can be 160 μm. In the related technology, the channel width-to-length ratio of the first transistor can be 160/8. In at least one disclosed embodiment, the channel width-to-length ratio of the first transistor can be 160/11, but this is not limited thereto.

As shown in FIG. 21, when the overlapping area between the gate metal layer and the source-drain metal layers of the first transistor M1 remains unchanged, the parasitic capacitance between the gate and the source-drain electrodes of the first transistor M1 does not change, which does not affect the bootstrap rise of PU's potential. Meanwhile, the leakage current of the first transistor M1 is reduced. With a smaller channel width-to-length ratio, the surge current of the first transistor M1 decreases, thereby improving its performance and reducing its performance drift.

In specific implementations, the channel length of the first transistor may increase from 8.5 μm to 11 μm, and the peak current per unit length of the first transistor can decrease from 7.87 μA/μm to 7.06 μA/μm.

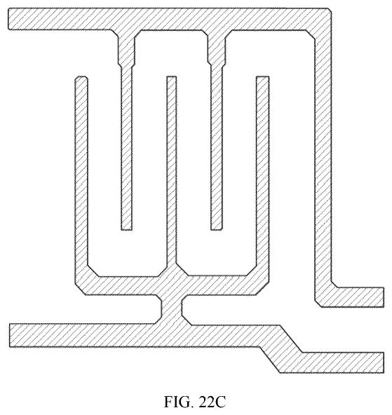

FIG. 22A shows the layout diagrams of the gate metal layer in FIG. 21, FIG. 22B shows the semiconductor layer in FIG. 21, and FIG. 22C shows the source-drain metal layers in FIG. 21 in FIG. 21, respectively.

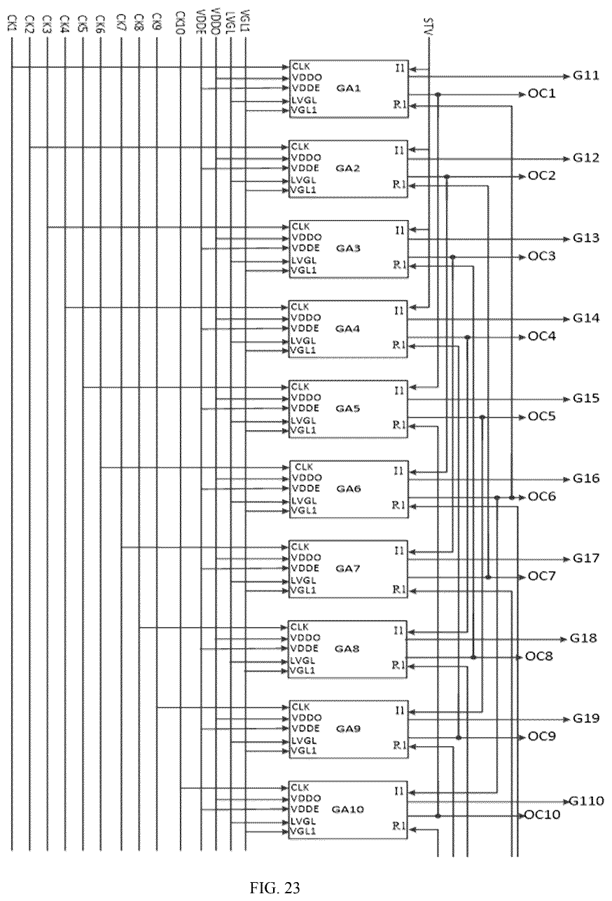

As shown in FIG. 23, at least one embodiment of the driving module disclosed herein includes multiple stages of driving circuits.

In FIG. 23: GA1 represents the first-stage driving circuit, GA2 represents the second-stage driving circuit, GA3 represents the third-stage driving circuit, and GA4 represents the fourth-stage driving circuit; GA5 represents the fifth-stage driving circuit, GA6 represents the sixth-stage driving circuit, GA7 represents the seventh-stage driving circuit, and GA8 represents the eighth-stage driving circuit; GA9 represents the ninth-stage driving circuit, and GA10 represents the tenth-stage driving circuit.

GA1 is connected to the first clock signal line CK1, GA2 is connected to the second clock signal line CK2, GA3 is connected to the third clock signal line CK3, and GA4 is connected to the fourth clock signal line CK4;

GA5 is connected to the fifth clock signal line CK5, GA6 is connected to the sixth clock signal line CK6, GA7 is connected to the seventh clock signal line CK7, and GA8 is connected to the eighth clock signal line CK8;

GA9 is connected to the ninth clock signal line CK9, and GA10 is connected to the tenth clock signal line CK10. (It should be noted that this application uses ten clock signal lines for illustrative purposes. In practical operations, the driving module may also be connected to other numbers of clock signal lines. For example, there may be 6, 8, 12, 14, or 16 clock signal lines, etc., without limitation.)

G11 represents the first-stage driving signal output terminal, G12 represents the second-stage driving signal output terminal, G13 represents the third-stage driving signal output terminal, and G14 represents the fourth-stage driving signal output terminal; G15 represents the fifth-stage driving signal output terminal, G16 represents the sixth-stage driving signal output terminal, G17 represents the seventh-stage driving signal output terminal, and G18 represents the eighth-stage driving signal output terminal; G19 represents the ninth-stage driving signal output terminal, and G110 represents the tenth-stage driving signal output terminal.

OC1 represents the first-stage carry output terminal, OC2 represents the second-stage carry output terminal, OC3 represents the third-stage carry output terminal, and OC4 represents the fourth-stage carry output terminal; OC5 represents the fifth-stage carry output terminal, OC6 represents the sixth-stage carry output terminal, OC7 represents the seventh-stage carry output terminal, and OC8 represents the eighth-stage carry output terminal; OC9 represents the ninth-stage carry output terminal, and OC10 represents the tenth-stage carry output terminal.

The input terminals of GA1, GA2, GA3, and GA4 are all connected to the start voltage line STV, which provides input signals to GA1, GA2, GA3, and GA4.

OC1 provides input signals to the input terminal of GA5, OC2 provides input signals to the input terminal of GA6, OC3 provides input signals to the input terminal of GA7, OC4 provides input signals to the input terminal of GA8, OC5 provides input signals to the input terminal of GA9, and OC6 provides input signals to the input terminal of GA10. That is, the carry output terminal of the (n−4)th-stage driving circuit provides input signals to the nth-stage driving circuit.

OC6 provides a reset signal to GA1, OC7 provides a reset signal to GA2, OC8 provides a reset signal to GA3, OC9 provides a reset signal to GA4, and OC10 provides a reset signal to GA5. That is, the carry output terminal of the nth-stage driving circuit provides a reset signal to the (n−5)th-stage driving circuit. For example, as referenced in FIG. 10, the carry output terminal of the nth-stage driving circuit provides a reset signal to the (n−5)th-stage driving circuit.

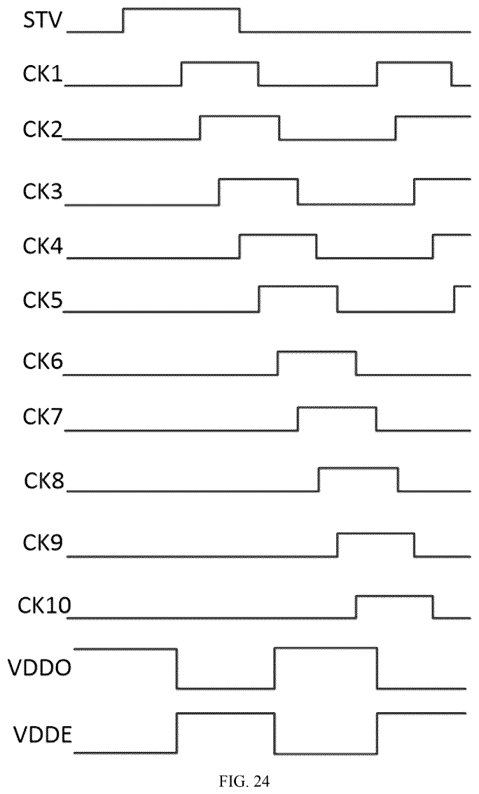

FIG. 24 shows waveform diagrams during operation for at least one embodiment of the driving module depicted in FIG. 23. These include waveforms of the start voltage provided by the start voltage line STV, the clock signals provided by each clock signal line, the first control voltage provided by VDDO, and the second control voltage provided by VDDE.

As shown in FIG. 24, The duration during which the start voltage remains at a high voltage is 6 H. Optionally, the start voltage line provides the initial driving voltage to transistors in the input circuits of the front four stages of driving circuits.

Each clock signal's potential remains high for 4 H, with a duty cycle of 40%. That is, the high-level time is 4 H, and the low-level time is 6 H.

The driving method described in the present disclosure is applied to the above-mentioned driving module. The driving method includes:

The input circuit controls the potential of the pull-up node based on the input signal provided by the input terminal;

Under the control of the first reset signal provided by the first reset terminal, the first reset circuit inputs the first voltage signal to the pull-up node;

Under the control of the second reset signal provided by the second reset terminal, the second reset circuit inputs the second voltage signal to the pull-up node;

The voltage value of the first voltage signal is greater than the voltage value of the second voltage signal.

In one embodiment of the present disclosure, when resetting the potential of the pull-up node, the first reset circuit connects the pull-up node to the first voltage terminal under the control of the first reset signal provided by the first reset terminal, thereby inputting the first voltage signal to the pull-up node. Subsequently, the second reset circuit connects the pull-up node to the second voltage terminal under the control of the second reset signal provided by the second reset terminal, thereby inputting the second voltage signal to the pull-up node. The voltage value of the first voltage signal is greater than that of the second voltage signal, which reduces the absolute value of the drain-source voltage of the transistor included in the first reset circuit, prevents characteristic drift of the transistor in the first reset circuit, and improves the reliability of display products.

In at least one embodiment of the present disclosure, the driving circuits in the driving module also include a second reset circuit, a driving output circuit, and an energy storage circuit.

The driving cycle includes five stages: the first stage, second stage, third stage, fourth stage, and fifth stage. The driving method includes:
During the first stage, the input terminal provides an effective input signal, and the input circuit controls the potential of the current-stage pull-up node to a first potential based on the input signal;
During the second stage, the driving output circuit supplies the first clock signal to the driving signal output terminal under the control of the potential at the pull-up node. The potential of the first clock signal is a second potential, and the energy storage circuit bootstraps the current-stage potential at the pull-up node;
During the third stage, the potential of the first clock signal falls from the second potential to a third potential. The driving output circuit supplies the first clock signal to the driving signal output terminal under the control of the potential at the pull-up node. As the potential of the first clock signal falls, the energy storage circuit pulls down the current-stage potential at the pull-up node;
During the fourth stage, under the control of the first reset signal, the first reset circuit connects the pull-up node to the first voltage terminal;
During the fifth stage, in subsequent m-stage driving circuits, the second reset circuit in the subsequent m-stage driving circuits connects the pull-up node to the second voltage terminal under the control of the potential of the first pull-down node from the subsequent m-stage driving circuits; m is a positive integer.

Optionally, the driving circuit also includes a first noise reduction circuit and a second noise reduction circuit. The first noise reduction circuit is electrically connected to the first noise reduction control terminal, and the second noise reduction circuit is electrically connected to the second noise reduction control terminal. Both the first noise reduction control terminal and the second noise reduction control terminal serve as input terminals for the front m stages. The driving cycle includes a noise reduction phase set before the first stage. The driving method further includes:
During the noise reduction phase, the first noise reduction circuit connects the first pull-down node to the second voltage terminal under the control of a signal from the input terminal provided by the front m stages. The second noise reduction circuit connects the second pull-down node to the second voltage terminal under the control of the signal from the input terminal provided by the front m stages.

The present disclosure also relates to a display device comprising the aforementioned driving module.

The above is a preferred embodiment of the present disclosure. It should be noted that those skilled in the art can make several modifications and improvements without departing from the principles disclosed herein, and these modifications and improvements shall also fall within the scope of the present disclosure.

1. A driving module, comprising multiple stages of driving circuits; the driving circuit comprises an input circuit, a first reset circuit, and a first pull-down noise reduction circuit;
the input circuit is electrically connected to the input terminal and the pull-up node, respectively, and is configured to control the potential of the pull-up node based on the input signal provided by the input terminal;
the first reset circuit is electrically connected to the first reset terminal, the pull-up node, and the first voltage terminal, respectively, and is configured to, under the control of the first reset signal provided by the first reset terminal, input the first voltage signal from the first voltage terminal to the pull-up node;
the first pull-down noise reduction circuit is electrically connected to the first pull-down node, the pull-up node, and the second voltage terminal, and is configured to, under the control of the potential of the first pull-down node, input the second voltage signal provided by the second voltage terminal to the pull-up node;
the voltage value of the first voltage signal is greater than the voltage value of the second voltage signal.

2. The driving module of claim 1, wherein the driving circuit further comprises a second reset circuit;
the second reset circuit is electrically connected to the first pull-down node, the pull-up node of the adjacent m-stage preceding driving circuit, and the second voltage terminal, respectively, and is configured to, under the control of the potential of the first pull-down node, control the conduction or disconnection between the pull-up node of the adjacent m-stage preceding driving circuit and the second voltage terminal;
m is a positive integer.

3. The driving module of claim 1, wherein the driving circuit further comprises a second reset circuit;
the second reset circuit is electrically connected to the first pull-down node, the pull-up node, and the second voltage terminal, respectively, and is configured to, under the control of the potential of the first pull-down node, control the connection or disconnection between the pull-up node and the second voltage terminal.

4. The driving module of claim 2, wherein the driving circuit further comprises a third reset circuit;
the third reset circuit is electrically connected to the second pull-down node, the pull-up node of the adjacent m-stage preceding driving circuit, and the second voltage terminal, respectively, and is configured to, under the control of the potential of the second pull-down node, control the conduction or disconnection between the pull-up node of the adjacent m-stage preceding driving circuit and the second voltage terminal.

5. The driving module of claim 3, wherein the driving circuit further comprises a third reset circuit;
the third reset circuit is electrically connected to the second pull-down node, the pull-up node, and the second voltage terminal, respectively, and is configured to, under the control of the potential of the second pull-down node, control the conduction or disconnection between the pull-up node and the second voltage terminal.

6. The driving module of claim 1, wherein the driving circuit further comprises a second pull-down noise reduction circuit;
the second pull-down noise reduction circuit is electrically connected to the second pull-down node, the pull-up node, and the second voltage terminal, respectively, and is configured to, under the control of the second pull-down node, input the second voltage signal provided by the second voltage terminal to the pull-up node.

7. The driving module of claim 1, wherein the driving circuit further comprises a first noise reduction circuit;
the first noise reduction circuit is electrically connected to the first noise reduction control terminal, the first pull-down node, and the second voltage terminal, respectively, and is configured to, under the control of the first noise reduction control signal provided by the first noise reduction control terminal, control the conduction or disconnection between the first pull-down node and the second voltage terminal;
the first noise reduction control terminal is either the input terminal of the adjacent m-stage preceding driving circuit or the first reset terminal.

8. The driving module of claim 7, wherein the driving circuit further comprises a second noise reduction circuit;
the second noise reduction circuit is electrically connected to the second noise reduction control terminal, the second pull-down node, and the second voltage terminal, respectively, and is configured to, under the control of the second noise reduction control signal provided by the second noise reduction control terminal, control the conduction or disconnection between the second pull-down node and the second voltage terminal;
the second noise reduction control terminal is either the input terminal of the adjacent m-stage preceding driving circuit or the first reset terminal; m is a positive integer.

9. The driving module of claim 1, wherein the first reset circuit comprises a first transistor;
the gate of the first transistor is electrically connected to the first reset terminal, the first terminal of the first transistor is electrically connected to the pull-up node, and the second terminal of the first transistor is electrically connected to the first voltage terminal.

10. (canceled)

11. The driving module of claim 2, wherein the second reset circuit comprises a second transistor:
the gate of the second transistor is electrically connected to the first pull-down node, the first terminal of the second transistor is electrically connected to the pull-up node of the adjacent m-stage preceding driving circuit, and the second terminal of the second transistor is electrically connected to the second voltage terminal.

12. The driving module of claim 3, wherein the second reset circuit comprises a second transistor:
the gate of the second transistor is electrically connected to the first pull-down node, the first terminal of the second transistor is electrically connected to the pull-up node, and the second terminal of the second transistor is electrically connected to the second voltage terminal.

13. The driving module of claim 4, wherein the third reset circuit comprises a third transistor:
the gate of the third transistor is electrically connected to the second pull-down node, the first terminal of the third transistor is electrically connected to the pull-up node of the adjacent m-stage preceding driving circuit, and the second terminal of the third transistor is electrically connected to the second voltage terminal.

14. The driving module of claim 5, wherein the third reset circuit comprises a third transistor:
the gate of the third transistor is electrically connected to the second pull-down node, the first terminal of the third transistor is electrically connected to the pull-up node, and the second terminal of the third transistor is electrically connected to the second voltage terminal.

15. The driving module of claim 7, wherein the first noise reduction circuit comprises a fourth transistor:
the gate of the fourth transistor is electrically connected to the first noise reduction control terminal, the first terminal of the fourth transistor is electrically connected to the first pull-down node, and the second terminal of the fourth transistor is electrically connected to the second voltage terminal.

16. The driving module of claim 8, wherein the second noise reduction circuit comprises a fifth transistor:
the gate of the fifth transistor is electrically connected to the second noise reduction control terminal, the first terminal of the fifth transistor is electrically connected to the second pull-down node, and the second terminal of the fifth transistor is electrically connected to the second voltage terminal.

17. The driving module of claim 1, wherein the driving circuit further comprises a driving signal output terminal and a drive reset circuit:
the drive reset circuit is electrically connected to the pull-down node, the driving signal output terminal, and the first voltage terminal, and is configured to, under the control of the potential of the pull-down node, control the conduction or disconnection between the driving signal output terminal and the first voltage terminal; or,
the drive reset circuit is electrically connected to the pull-down node, the driving signal output terminal, and the third voltage terminal, and is configured to, under the control of the potential of the pull-down node, control the conduction or disconnection between the driving signal output terminal and the third voltage terminal; the third voltage terminal is different from the first voltage terminal.

18.-21. (canceled)

22. A driving method applicable to the driving module of claim 1, comprising:
controlling, by the input circuit, the potential of the pull-up node based on the input signal provided by the input terminal;
inputting, by the first reset circuit, a first voltage signal to the pull-up node under the control of the first reset signal provided by the first reset terminal;
inputting, by the first pull-down noise reduction circuit, a second voltage signal to the pull-up node under the control of the first pull-down node;
wherein the voltage value of the first voltage signal is greater than the voltage value of the second voltage signal.

23. The driving method of claim 22, wherein the driving circuits in the driving module further comprise a second reset circuit, a driving output circuit, and an energy storage circuit;
the driving cycle comprises a first stage, a second stage, a third stage, a fourth stage, and a fifth stage, and the driving method comprises:
during the first stage, the input terminal provides an effective input signal, and the input circuit controls the pull-up node potential for the current stage to reach a first potential based on the input signal;
during the second stage, the driving output circuit supplies a first clock signal to the driving signal output terminal under the control of the potential at the pull-up node, the potential of the first clock signal is a second potential, and the energy storage circuit bootstraps the potential of the current-stage pull-up node;
during the third stage, the potential of the first clock signal falls from the second potential to a third potential, the driving output circuit supplies the first clock signal to the driving signal output terminal under the control of the potential at the pull-up node, as the potential of the first clock signal falls, the energy storage circuit pulls down the potential of the current-stage pull-up node;
during the fourth stage, under the control of the first reset signal, the first reset circuit connects the pull-up node to the first voltage terminal;
during the fifth stage, the second reset circuit in the subsequent m-stage driving circuits connects the pull-up node to the second voltage terminal under the control of the potential of the first pull-down node in the subsequent m-stage driving circuits;
m is a positive integer.

24. The driving method of claim 23, wherein the driving circuit further comprises a first noise reduction circuit and a second noise reduction circuit; the first noise reduction circuit is electrically connected to the first noise reduction control terminal, and the second noise reduction circuit is electrically connected to the second noise reduction control terminal; both the first noise reduction control terminal and the second noise reduction control terminal are input terminals of the m-stage preceding driving circuits; the driving cycle comprises a noise reduction phase set before the first stage;
the driving method further comprises:
during the noise reduction phase, the first noise reduction circuit controls the conduction between the first pull-down node and the second voltage terminal under the control of signals provided by the input terminals of the m-stage preceding driving circuits; the second noise reduction circuit controls the conduction between the second pull-down node and the second voltage terminal under the control of signals provided by the input terminals of the m-stage preceding driving circuits.

25. (canceled)

26. (canceled)

27. A display device, comprising the driving module of claim 1.
